(19) United States
(12) Patent Application Publication
(10) Pub. No.: US 2026/0104596 A1
(43) Pub. Date: Apr. 16, 2026

(54) METHODS OF FORMING OPTICAL COMBINERS

(71) Applicant: CORNING INCORPORATED, CORNING, NY (US)

(72) Inventors: Paulo Clovis Dainese, JR., Painted Post, NY (US); Marissa Granados Baez, Norwalk, CT (US); Cameron Robert Nelson, Oak Park, CA (US); Abhinav Nishant, Painted Post, NY (US)

(21) Appl. No.: 19/349,446

(22) Filed: Oct. 3, 2025

Related U.S. Application Data
(60) Provisional application No. 63/705,865, filed on Oct. 10, 2024.

(51) Int. Cl. G02B 27/10; G02B 27/01

(52) U.S. Cl. CPC G02B 27/10; G02B 27/0101; G02B 2027/013

(57) ABSTRACT

A method of forming an optical combiner having a light guide and an in-coupler disposed therein includes: selecting an optical combiner parameter set including a grating period of the in-coupler, a thickness-to-width ratio of the optical combiner, a refractive index of the light guide, and a field of view of the optical combiner; calculating a total in-coupling efficiency of the optical combiner as a function of an angle of incidence of an incident light comprising a wavelength within the field of view of the optical combiner; and configuring the optical combiner parameter set to maximize a relative in-coupling efficiency of the optical combiner, defined as a minimum field efficiency normalized by a theoretical efficiency maximum of the optical combiner.

This application claims the benefit of priority to U.S. Provisional Patent Application Ser. No. 63/705,865 filed on Oct. 10, 2024, the content of which is relied upon and incorporated herein by reference in its entirety.

### FIELD

The present disclosure relates to optical combiners and, in particular, to methods of forming thin optical combiners having improved in-coupling efficiency.

### TECHNICAL BACKGROUND

The optical combiner architecture is a popular choice for augmented reality (AR) systems. A typical optical combiner generally includes an in-coupling element (e.g. a grating) and a light guide. In a typical optical combiner, external light is coupled through the in-coupling element into the light guide. The field of view of an optical combiner is determined by the angular extent of the light field that can be efficiently coupled at the in-coupling element and propagate through the light guide by total internal reflection (TIR).

To obtain a lightweight optical combiner (e.g., for AR systems), the thickness of the light guide may be reduced. However, reducing the thickness of the light guide poses various challenges in designing in-coupling gratings for thin optical combiners with improved in-coupling efficiency.

Accordingly, a need exists for a method of forming a thin optical combiner with improved in-coupling efficiency.

### SUMMARY

The need is addressed by embodiments, related to methods of forming an optical combiner and methods of coupling an incident light into an optical combiner, provided herein. Also provided is a summary of various aspects, with details of each aspect, including terms and features described in each aspect, described and illustrated in subsequent paragraphs and drawings.

According to a first aspect A1, a method of forming an optical combiner comprising a light guide and an in-coupler disposed therein may comprise selecting an optical combiner parameter set comprising a grating period (∧) of the in-coupler, a thickness-to-width ratio (t/w) of the optical combiner, a refractive index (n_{substrate}) of the light guide, and a field of view of the optical combiner; calculating a total in-coupling efficiency (ηₜₒₜₐₗ) of the optical combiner as a function of an angle of incidence (θᵢₙ) of an incident light comprising a wavelength (λ) within the field of view of the optical combiner, wherein the total in-coupling efficiency (ηₜₒₜₐₗ) of the optical combiner is calculated according to Eq. (1):

$${η}_{total} = f {η}_{1 T} ( \frac{1 - {η}_{0 R}^{N}}{1 - {η}_{0 R}} ) + {f}_{N + 1} {η}_{1 T} {η}_{0 R}^{N} ; \qquad Eq . ( 1 )$$

wherein η_{1T} is a first-order deflection efficiency of the optical combiner; η_{0R} is a zeroth-order reflection efficiency of the optical combiner; f is a fractional area of the in-coupler where the incident light interacts once with the in-coupler defined by Eq. (2):

$$f = \frac{2 t}{w} tan {θ}_{r} , \qquad Eq . ( 2 ) ;$$

where t is a thickness of the light guide and w is a width of the in-coupler, and θᵣ is a reflected angle of the incident light from a back surface of the light guide defined by Eq. (3):

$${n}_{substrate} sin {θ}_{r} = \frac{λ}{Λ} sin {θ}_{in} ; \qquad Eq . ( 3 )$$

N of Eq. (1) is the number of secondary interactions determined by

$$N = ⌊ \frac{1}{f} ⌋ ;$$

and f_{N+1} is a remaining fractional area of the in-coupler where the incident light experiences N secondary interactions calculated according to f_{N+1}=1−Nf; and configuring the optical combiner parameter set to maximize a relative in-coupling efficiency of the optical combiner, defined as a minimum field efficiency (MFE=min[ηₜₒₜₐₗ]) normalized by a theoretical efficiency maximum (ηₘₐₓ) of the optical combiner, given by ηₘₐₓ=η_{1T} if f≥1 or ηₘₐₓ=f if f<1.

A second aspect A2 includes the method according to the first aspect A1, wherein the optical combiner parameter set may further comprise the width (w) of the in-coupler, the thickness (t) of the light guide, a height (h) of an in-coupling grating structure, a width (d) of the in-coupling grating structure, a slant angle (θₛ) of the in-coupling grating structure, a refractive index (n_{grating}) of the in-coupling grating structure, a duty cycle of the in-coupler, or combinations thereof.

According to a third aspect A3, a method of forming an optical combiner comprising a light guide and an in-coupler comprising a plurality of grating structures disposed therein, wherein each grating structure of the plurality of grating structures comprises a shape profile, may comprise determining a relative in-coupling efficiency of the optical combiner; and iteratively converging the relative in-coupling efficiency of the optical combiner by conducting at least one of the following: configuring the shape profile of each grating structure of the plurality of grating structures to maximize the relative in-coupling efficiency of the optical combiner; and configuring the shape profile of each grating structure of the plurality of grating structures to adjust the relative in-coupling efficiency of the optical combiner such that the relative in-coupling efficiency of the optical combiner is within 40% of the theoretical efficiency maximum (ηₘₐₓ) of the optical combiner, wherein the optical combiner comprises a grating period (∧) of the in-coupler, a thickness-to-width ratio (t/w) of the optical combiner, a refractive index (n_{substrate}) of the light guide, and a field of view of the optical combiner; and the relative in-coupling efficiency of the optical combiner is defined as a minimum field efficiency (MFE=min[ηₜₒₜₐₗ]) normalized by a theoretical efficiency maximum (ηₘₐₓ) of the optical combiner, where ηₜₒₜₐₗ is a total in-coupling efficiency of the optical combiner calculated as a function of an angle of incidence (θᵢₙ) of an incident light comprising a wavelength (λ) within the field of view of the optical combiner according to Eq. (1) defined hereinabove; and the theoretical efficiency maximum (nₘₐₓ) of the optical combiner is given by ηₘₐₓ=η_{1T} if f≥1 or ηₘₐₓ=f if f<1, where f is a fractional area of the in-coupler where the incident light interacts once with the in-coupler defined by Eq. (2) defined hereinabove.

A fourth aspect A4 includes the method according to the third aspect A3, wherein each grating structure of the plurality of grating structures comprises a material profile, and wherein the method may further comprise iteratively converging the relative efficiency of the optical combiner by conducting at least one of the following: configuring the material profile of each grating structure of the plurality of grating structures to maximize the relative in-coupling efficiency of the optical combiner; and configuring the material profile of each grating structure of the plurality of grating structures to adjust adjusting the relative in-coupling efficiency such that the relative in-coupling efficiency is within 40% of the theoretical efficiency maximum (nₘₐₓ) of the optical combiner, wherein the material profile comprises dielectric materials, plasmonic materials, or combinations thereof.

A fifth aspect A5 includes the method according to the third aspect A3 or the fourth aspect A4, wherein the iteratively converging of the relative efficiency of the optical combiner may further comprise applying at least one boundary condition, wherein the applying of the at least one boundary condition controls formation of a boundary in the in-coupler.

A sixth aspect A6 includes the method according to the fifth aspect, wherein the at least one boundary condition is applied according to Eq. (4):

$${u}_{⊥} ( {θ}_{in} , λ ) = {w}_{1 T} {g}_{1 T} + {w}_{0 R} {g}_{0 R} , \qquad Eq . ( 4 )$$

wherein u_{⊥} is the magnitude of displacement in a boundary of the shape profile at each iteration, g_{1T} and g_{0R} are functions describing the shape profiles to be maximized so that changes in both the first-order deflection efficiency and the zeroth-order reflection efficiency are maximized, weight of the first-order deflection efficiency (w_{1T}) is calculated as w_{1T}=1/η_{1T}, and weight of the zeroth-order reflection efficiency (w_{0R}) is calculated as w_{0R}=1/η_{0R}.

According to a seventh aspect A7, a method of coupling an incident light into an optical combiner comprising an in-coupler and a light guide disposed therein may comprise diffracting the incident light comprising a wavelength (λ) with the in-coupler into the light guide at an angle of incidence (θᵢₙ) of the incident light relative to the normal of an incident surface of the optical combiner within a field of view of the optical combiner, wherein the in-coupler comprises a grating period (∧) and a width (w); the light guide comprises a refractive index (n_{substrate}) and a thickness (t); and the optical combiner has a relative in-coupling efficiency greater than or equal to 0.5 and less than or equal to 1.0, where the relative in-coupling efficiency of the optical combiner is defined as a minimum field efficiency (MFE=min[ηₜₒₜₐₗ]) normalized by a theoretical efficiency maximum (ηₘₐₓ) of the optical combiner, where ηₜₒₜₐₗ is a total in-coupling efficiency of the optical combiner calculated as a function of an angle of incidence (θᵢₙ) of the incident light within the field of view according to Eq. (1) defined hereinabove; and the theoretical efficiency maximum (ηₘₐₓ) of the optical combiner is given by ηₘₐₓ=η_{1T} if f≥1 or ηₘₐₓ=f if f<1, where f is a fractional area of the in-coupler where the incident light interacts once with the in-coupler defined by Eq. (2) defined hereinabove.

An eighth aspect A8 includes the method according to any one of the first aspect A1 to the seventh aspect A7, wherein the maximized relative in-coupling efficiency of the optical combiner is greater than or equal to 0.5 and less than or equal to 1.0 or greater than or equal to 0.8 and less than or equal to 1.0.

A ninth aspect A9 includes the method according to any one of the first aspect A1 to the eighth aspect A8, wherein the incident light has a wavelength of greater than or equal to 350 nm and less than or equal to 730 nm.

A tenth aspect A10 includes the method according to any one of the first aspect A1 to the ninth aspect A9, wherein the incident light has a TE/TM polarization extinction ratio of greater than or equal to 20 dB.

An eleventh aspect A11 includes the method according to any one of the first aspect A1 to the tenth aspect A10, wherein the thickness-to-width ratio (t/w) of the optical combiner is greater than or equal to 5×10⁻⁵ and less than or equal to 5×10⁻¹; greater than or equal to 5×10⁻⁵ and less than or equal to 1×10⁻¹; or greater than or equal to 5×10⁻⁵ and less than or equal to 1×10⁻².

A twelfth aspect A12 includes the method according to any one of the first aspect A1 to the eleventh aspect A11, wherein thickness-to-width ratio (t/w) of the optical combiner is greater than or equal to 5×10⁻⁵ and less than or equal to 1×10⁻²; and the maximized relative in-coupling efficiency of the optical combiner is greater than or equal to 0.8 and less than or equal to 1.0.

A thirteenth aspect A13 includes the method according to any one of the first aspect A1 to the twelfth aspect A12, wherein the field of view of the optical combiner is greater than or equal to −60° and less than or equal to +60°, relative to the normal of an incident surface of the optical combiner.

A fourteenth aspect A14 includes the method according to any one of the first aspect A1 to the thirteenth aspect A13, wherein the angle of incidence (fin) of the incident light is greater than or equal to −25° and less than or equal to +25°, relative to the normal of an incident surface of the optical combiner.

A fifteenth aspect A15 includes the method according to any one of the first aspect A1 to the fourteenth aspect A14, wherein the light guide comprises SiN, TiO₂, SiO₂, or combinations thereof.

A sixteenth aspect A16 includes the method according to any one of the first aspect A1 to the fifteenth aspect A15, wherein the refractive index (n_{substrate}) of the light guide is greater than or equal to 1.8 and less than or equal to 2.7, as measured in a visible wavelength range from 350 nm to 800 nm.

A seventeenth aspect A17 includes the method according to any one of the first aspect A1 to sixteenth aspect A16, wherein the light guide comprises a single layer of SiN, TiO₂, SiO₂, or combinations thereof.

An eighteenth aspect A18 includes the method according to any one of the first aspect A1 to the seventeenth aspect A17, wherein the theoretical efficiency maximum (nₘₐₓ) of the optical combiner is greater than or equal to 0.8 and less than or equal to 1.0.

A nineteenth aspect A19 includes the method according to any one of the second aspect A2 to the eighteenth aspect A18, wherein the thickness (t) of the light guide is greater than or equal to 10 μm and less than or equal to 2000 μm.

A twentieth aspect A20 includes the method according to any one of the first aspect A1 to the nineteenth aspect A19, wherein the grating period (∧) of the in-coupler is greater than or equal to 150 nm and less than or equal to 3000 nm.

Additional features and advantages of the methods of forming thin optical combiners described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is a schematic illustration of light propagation in an example optical combiner system, according to one or more embodiments shown and described herein;

FIG. 2 is a schematic illustration of a secondary interaction in the example optical combiner system of FIG. 1;

FIG. 3 is a flow diagram of a method of forming an optical combiner with maximized efficiency, according to one or more embodiments shown and described herein;

FIG. 4A schematically depicts an example optical combiner comprising a slanted relief grating with efficiency maximized utilizing the method of FIG. 3, according to one or more embodiments shown and described herein;

FIG. 4B schematically depicts an example optical combiner comprising a single ridge relief grating with efficiency maximized utilizing the method of FIG. 3, according to one or more embodiments shown and described herein;

FIG. 4C schematically depicts an example optical combiner comprising a double ridge relief grating with efficiency maximized utilizing the method of FIG. 3, according to one or more embodiments shown and described herein;

FIG. 4D schematically depicts an example optical combiner comprising a block-and-pillar relief grating with efficiency maximized utilizing the method of FIG. 3, according to one or more embodiments shown and described herein;

FIG. 5 is a flow diagram of a step of the method of FIG. 3, according to one or more embodiments shown and described herein;

FIG. 6 is a flow diagram of another method of forming optical combiner system, according to one or more embodiments shown and described herein;

FIG. 7 is a graph of maximized relative in-coupling efficiency and relative first-order deflection efficiency data plotted as a function of a thickness-to-width ratio (t/w) for example optical combiners, according to one or more embodiments shown and described herein;

FIG. 8 is a graph of total number of grating interactions as a function of the angle of incidence (θᵢₙ) for example optical combiners having various thickness-to-width ratios (t/w), according to one or more embodiments shown and described herein;

FIG. 9 is a graph of relative in-coupling efficiency plotted as a function of a thickness-to-width ratio (t/w) for gratings of example optical combiners of FIG. 8; and

FIG. 10 schematically depicts an example optical combiner with grating structures modified utilizing the method of FIG. 6, according to one or more embodiments shown and described herein.

### DETAILED DESCRIPTION

Reference will now be made in detail to various embodiments of methods of forming thin optical combiners having improved in-coupling efficiency.

In some embodiments, a method of forming an optical combiner comprising a light guide and an in-coupler disposed therein comprises selecting an optical combiner parameter set comprising a grating period (∧) of the in-coupler, a thickness-to-width ratio (t/w) of the optical combiner, a refractive index (n_{substrate}) of the light guide, and a field of view of the optical combiner; calculating a total in-coupling efficiency (ηₜₒₜₐₗ) of the optical combiner as a function of an angle of incidence (θᵢₙ) of an incident light comprising a wavelength (λ) within the field of view of the optical combiner, wherein the total in-coupling efficiency (ηₜₒₜₐₗ) of the optical combiner is calculated according to Eq. (1) defined hereinabove; and configuring the optical combiner parameter set to maximize a relative in-coupling efficiency of the optical combiner, defined as a minimum field efficiency (MFE=min[ηₜₒₜₐₗ]) normalized by a theoretical efficiency maximum (ηₘₐₓ) of the optical combiner, given by ηₘₐₓ=η_{1T} if f≥1 or ηₘₐₓ=f if f<1, where f is a fractional area of the in-coupler where the incident light interacts once with the in-coupler defined by Eq. (2) defined hereinabove.

In other embodiments, a method of forming an optical combiner comprising a light guide and an in-coupler comprising a plurality of grating structures disposed therein, wherein each grating structure of the plurality of grating structures comprises a shape profile, comprises determining a relative in-coupling efficiency of the optical combiner; and iteratively converging the relative in-coupling efficiency of the optical combiner by conducting at least one of the following: configuring the shape profile of each grating structure of the plurality of grating structures to maximize the relative in-coupling efficiency of the optical combiner; and configuring the shape profile of each grating structure of the plurality of grating structures to adjust the relative in-coupling efficiency of the optical combiner such that the relative in-coupling efficiency of the optical combiner is within 40% of the theoretical efficiency maximum (ηₘₐₓ) of the optical combiner, wherein the optical combiner comprises a grating period (∧) of the in-coupler, a thickness-to-width ratio (t/w) of the optical combiner, a refractive index (n_{substrate}) of the light guide, and a field of view of the optical combiner; and the relative in-coupling efficiency of the optical combiner is defined as a minimum field efficiency (MFE=min[nₜₒₜₐₗ]) normalized by a theoretical efficiency maximum (ηₘₐₓ) of the optical combiner, where ηₜₒₜₐₗ is a total in-coupling efficiency of the optical combiner calculated as a function of an angle of incidence (θᵢₙ) of an incident light comprising a wavelength (λ) within the field of view of the optical combiner according to Eq. (1) defined hereinabove; and the theoretical efficiency maximum (nₘₐₓ) of the optical combiner is given by ηₘₐₓ=η_{1T} if f≥1 or ηₘₐₓ=f if f<1, where f is a fractional area of the in-coupler where the incident light interacts once with the in-coupler defined by Eq. (2) defined hereinabove.

In some embodiments, a method of coupling an incident light into an optical combiner comprising an in-coupler and a light guide disposed therein comprises diffracting the incident light comprising a wavelength (λ) with the in-coupler into the light guide at an angle of incidence (θᵢₙ) of the incident light relative to the normal of an incident surface of the optical combiner within a field of view of the optical combiner, wherein the in-coupler comprises a grating period (∧) and a width (w); the light guide comprises a refractive index (n_{substrate}) and a thickness (t); and the optical combiner has a relative in-coupling efficiency greater than or equal to 0.5 and less than or equal to 1.0, where the relative in-coupling efficiency of the optical combiner is defined as a minimum field efficiency (MFE=min[ηₜₒₜₐₗ]) normalized by a theoretical efficiency maximum (ηₘₐₓ) of the optical combiner, where ηₜₒₜₐₗ is a total in-coupling efficiency of the optical combiner calculated as a function of an angle of incidence (θᵢₙ) of the incident light within the field of view according to Eq. (1) defined hereinabove; and the theoretical efficiency maximum (ηₘₐₓ) of the optical combiner is given by ηₘₐₓ=η_{1T} if f≥1 or ηₘₐₓ=f if f<1, where f is a fractional area of the in-coupler where the incident light interacts once with the in-coupler defined by Eq. (2) defined hereinabove.

Various embodiments of methods of forming thin optical combiners will be described herein with specific reference to the appended drawings.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example, up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

As used herein, the term “angle of incidence”, “incidence angle”, or “θᵢₙ” refers to the angle between a ray of light incident at an interface between the in-coupler and the light guide and the normal to the interface at the point of incidence.

As used herein, the term “field of view” or “FOV” refers to the angular extent of area that can be imaged by the optical combiner.

As used herein, the term “relative in-coupling efficiency” refers to a minimum value of total in-coupling efficiency (ηₜₒₜₐₗ), also termed as a minimum field efficiency (MFE), calculated as a function of angle of incidence (θᵢₙ) of an incident light within the field of view, normalized by a theoretical efficiency maximum ηₘₐₓ of the optical combiner.

As used herein, the term “a thickness-to-width ratio (t/w)” of an optical combiner refers to a ratio between the thickness (t) of the light guide and a width (w) of the light-coupling area such as a width of the in-coupler.

As used herein, the term “grating period” or “∧” of an in-coupler refers to the period of an in-coupling grating structure along a direction in which the in-coupling grating structure is disposed on the in-coupler. As understood by one of skilled in the art, depending on the grating design, an in-coupler may have in-coupling grating structures disposed along one or more directions on an in-coupler, and therefore an in-coupler may have one or more grating periods.

As described herein, to obtain a lightweight optical combiner system (e.g., for AR systems), the thickness of the light guide may be reduced. However, reducing the thickness of a light guide leads to increased secondary interactions (i.e., subsequent coupling interactions between an incident light and the in-coupler after the incident light has diffracted into the light guide and reflected off the back surface of the light guide), which may result in loss of in-coupling efficiency. Conventional solutions to reduce secondary interactions include adding additional optical elements (e.g. a second grating on the opposite site of the light guide or an additional interlayer of high-index material or polarization-dependent material) to redirect the path of the diffracted incident light away from the in-coupler or to reduce the coupling between the diffracted incident light and the grating. However, these methods either present additional challenges in maintaining the field of view or geometric accuracy of the image or they have not been reduced to practice experimentally.

Disclosed herein are methods of forming a thin optical combiner that mitigate the aforementioned problems. The methods of forming an optical combiner described herein improve the in-coupling efficiency by considering the zeroth-order reflection efficiency η_{0R}(θᵣ) during the secondary interactions, where θᵣ is the angle of the diffracted incident light reflected off the grating. In particular, the methods may involve a parametrical maximization process, which considers possible combinations of the first-order deflection efficiency η_{1T}(θᵢₙ) and the zeroth-order reflection efficiency η_{0R}(θᵣ) for all incident angles θᵢₙ within the field of view of an optical combiner and configures parameters defining the optical combiner to maximize its relative in-coupling efficiency. Additionally, the methods may involve a shape modification process, which modifies individual shape profiles of grating structures disposed in an in-coupler of an optical combiner to maximize the relative in-coupling efficiency of the optical combiner. The parametrical maximization process and the shape modification process may be carried out along, in any combinations, or in any sequences. By incorporating both the first-order deflection efficiency and the zeroth-order reflection efficiency into consideration, embodiments of optical combiners described and disclosed herein achieve improved in-coupling efficiencies within 40% or even 20% of their theoretical efficiency maxima.

Unless explicitly stated, steps, materials, and/or properties, including ranges, described with respect to one method herein may apply with respect to another method described herein.

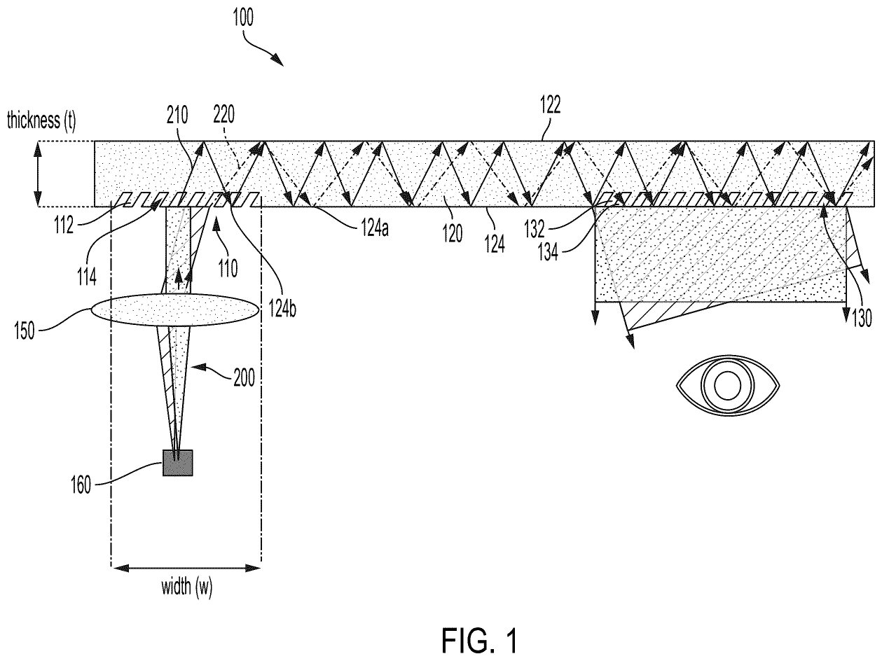

Referring now to FIG. 1, an optical combiner 100 may generally be described as including an in-coupler 110, a light guide 120, and an out-coupler 130. The in-coupler 110 may be an in-coupling grating having periodic in-coupling grating structures 112 and periodic in-coupling grooves 114 between the in-coupling grating structures 112. The out-coupler 130 may be an out-coupling grating having periodic out-coupling grating structures 132 and periodic out-coupling grooves 134 between the out-coupling grating structures 132. After being collimated by collimating optics 150, light 200 from a source 160 (e.g. a light source, an image source, or a microdisplay) is incident on the in-coupler 110, and light (e.g. 210 and 220) is coupled into the light guide 120 through the in-coupler 110. After being coupled into the light guide 120, light (e.g. 210 and 220) is reflected off the back surface 122 of the light guide 120 due to total-internal reflection (TIR). Some reflected light (e.g. 220) is incident on the front surface 124a of the light guide 120 away from the in-coupler 110 and therefore can propagate through the light guide 120 to the out-coupler 130 via TIR. However, some reflected light (e.g. 210) is incident on the interface 124b between the in-coupler 110 and the light guide 120. When light is incident on the interface 124b between the in-coupler 110 and the light guide 120, it may undergo a secondary interaction with the in-coupler 110 as shown in FIG. 1. As the thickness of optical combiner 100 decreases, the number of secondary interactions increases due to shortened optical path length. As explained below, secondary interactions may provide additional light loss channel in an optical combiner 100 that can affect the brightness and quality of the out-coupled image.

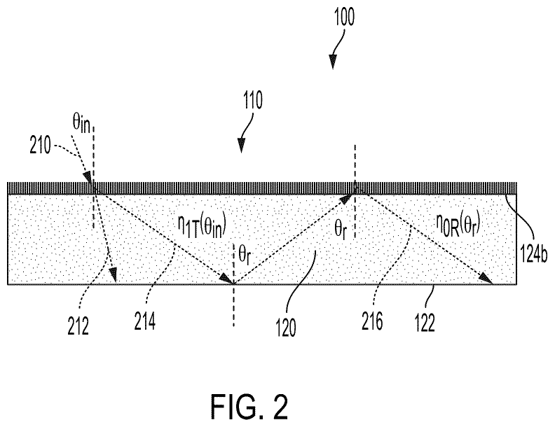

For example, referring now to FIG. 2, when light 210 is incident on the in-coupler 110 at an angle θᵢₙ, it may enter the light guide 120 and partly deflect into the first-order deflection 214 with an efficiency of η_{1T}(θᵢₙ). The deflected beam 214 reflects off the back surface 122 of the light guide 120 at an angle of θᵣ, and the reflected beam 210 incidents on the interface 124b between the in-coupler 110 and the light guide 120 and interacts with the in-coupler 110 again—that is, the secondary interaction. Part of the reflected beam 210 reflects off the interface 124b between the in-coupler 110 and the light guide 120 and continues to propagate in the light guide 120 with a zeroth-order reflection efficiency of η_{0R}(θᵣ). Considering conservation of energy and time-reversal symmetry, the total in-coupling efficiency ηₜₒₜₐₗ of the in-coupler 110 is bounded by 1, according to Eq. (5):

$${η}_{1 T} ( {θ}_{in} ) + {η}_{0 R} ( {θ}_{r} ) \leq 1 \qquad Eq . ( 5 )$$

However, conservation of energy and time-reversal symmetry also indicate that, when the zeroth-order reflection efficiency (η_{0R}(θᵣ)) decreases, losses due to the secondary interaction increases.

Different from the conventional approaches, which generally attempt to maximize the deflection efficiency and avoid the secondary interactions by redirecting the reflected beam 214 or reducing the coupling at the interface 124b, the presently disclosed embodiments are directed to methods of forming an optical combiner 100 by considering possible combinations of the first-order deflection efficiency η_{1T}(θᵢₙ) and the zeroth-order reflection efficiency η_{0R}(θᵣ) for incident angles θᵢₙ within the field of view to maximize the total in-coupling efficiency ηₜₒₜₐₗ(θᵢₙ) of the optical combiner 100.

### Parametrical Maximization

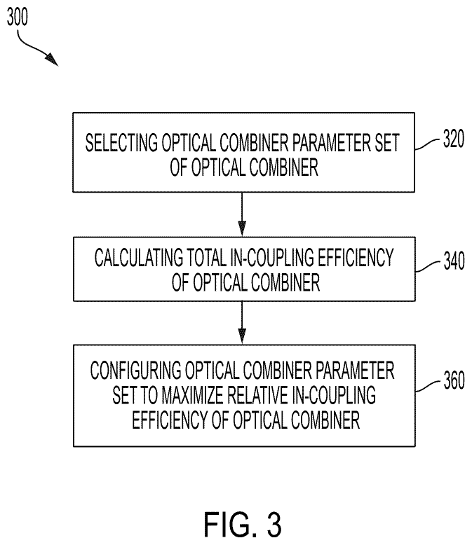

Referring now to FIG. 3 and as shown in FIG. 1, a method 300 of forming an optical combiner 100 comprising a light guide 120 and an in-coupler 110 disposed therein begins at block 320 with selecting an optical combiner parameter set.

According to embodiments, the optical combiner parameter set includes a grating period (∧) of the in-coupler 110, a thickness-to-width ratio (t/w) of the optical combiner 100, a refractive index (n_{substrate}) of the light guide 120, and a field of view of the optical combiner 100. According to other embodiments, the optical combiner parameter set may further include a width (w) of the in-coupler 110, a thickness (t) of the light guide 120, a height (h) of an in-coupling grating structure 112, a width (d) of the in-coupling grating structure 112, a slant angle (θₛ) of the in-coupling grating structure 112, a refractive index (n_{grating}) of the in-coupling grating structure 112, a duty cycle of the in-coupler 110, or combinations thereof. In embodiments in which the in-coupling grating structure 112 comprises cylindrical structures, the width (d) is the diameter of the cylindrical structures. Furthermore, in embodiments in which the structures of the in-coupling grating structure 112 are non-uniform in shape, the width (d) of the structures is the largest width dimension of these non-uniform structures.

As used herein, the term “duty cycle” refers to the ratio of the width (d) of an in-coupling grating structure 112 to a grating period (∧) of the in-coupler 110, as measured in the same direction. It is understood by those skilled in the art that a duty cycle of an in-coupler is related to the pattern of grating structures disposed on the in-coupler, and an in-coupler may have one or more duty cycles or variable duty cycles depending on the design of the in-coupler. For example, a simple, single ridge relief grating may have grating structures that include periodically repeated rectangular ridges with the same width (d) and the same separation (g) between each of the periodically repeated rectangular ridges. The single ridge relief grating may have one grating period defined as ∧=d+g, and one duty cycle defined as the ratio of d to A, (i.e., d/∧), which may also be expressed as a percentage.

In embodiments, the refractive index (n_{substrate}) of the light guide 120 may be greater than or equal to 1.8 in a visible wavelength range from 350 nm to 800 nm, such as greater than or equal to 1.8 and less than or equal to 2.7, greater than or equal to 1.8 and less than or equal to 2.5, or greater than or equal to 1.8 and less than or equal to 2.2, as measured in a visible wavelength range from 350 nm to 800 nm. In some embodiments, the light guide 120 may comprise SiN, TiO₂, SiO₂, or combinations thereof. In other embodiments, the light guide 120 may be a single layer or a multi-layer substrate. In specific embodiments, the light guide 120 may be a single layer of SiN, TiO₂, SiO₂, or combinations thereof.

In embodiments, the thickness (t), as shown, for example, in FIG. 1, of the light guide 120 may be greater than or equal to 10 μm and less than or equal to 2000 μm, such as greater than or equal to 10 μm and less than or equal to 1500 μm, greater than or equal to 10 μm and less than or equal to 1200 μm, greater than or equal to 10 μm and less than or equal to 1000 μm, greater than or equal to 10 μm and less than or equal to 800 μm, greater than or equal to 10 μm and less than or equal to 500 μm, greater than or equal to 10 μm and less than or equal to 300 μm, greater than or equal to 10 μm and less than or equal to 100 μm, greater than or equal to 10 μm and less than or equal to 80 μm, greater than or equal to 10 μm and less than or equal to 50 μm, greater than or equal to 10 μm and less than or equal to 30 μm, greater than or equal to 30 μm and less than or equal to 2000 μm, greater than or equal to 30 μm and less than or equal to 1500 μm, greater than or equal to 30 μm and less than or equal to 1200 μm, greater than or equal to 30 μm and less than or equal to 1000 μm, greater than or equal to 30 μm and less than or equal to 800 μm, greater than or equal to 30 μm and less than or equal to 500 μm, greater than or equal to 30 μm and less than or equal to 300 μm, greater than or equal to 30 μm and less than or equal to 100 μm, greater than or equal to 30 μm and less than or equal to 80 μm, greater than or equal to 30 μm and less than or equal to 50 μm, greater than or equal to 50 μm and less than or equal to 2000 μm, greater than or equal to 50 μm and less than or equal to 1500 μm, greater than or equal to 50 μm and less than or equal to 1200 μm, greater than or equal to 50 μm and less than or equal to 1000 μm, greater than or equal to 50 μm and less than or equal to 800 μm, greater than or equal to 50 μm and less than or equal to 500 μm, greater than or equal to 50 μm and less than or equal to 300 μm, greater than or equal to 50 μm and less than or equal to 100 μm, greater than or equal to 50 μm and less than or equal to 80 μm, greater than or equal to 80 μm and less than or equal to 2000 μm, greater than or equal to 80 μm and less than or equal to 1500 μm, greater than or equal to 80 μm and less than or equal to 1200 μm, greater than or equal to 80 μm and less than or equal to 1000 μm, greater than or equal to 80 μm and less than or equal to 800 μm, greater than or equal to 80 μm and less than or equal to 500 μm, greater than or equal to 80 μm and less than or equal to 300 μm, greater than or equal to 80 μm and less than or equal to 100 μm, greater than or equal to 100 μm and less than or equal to 2000 μm, greater than or equal to 100 μm and less than or equal to 1500 μm, greater than or equal to 100 μm and less than or equal to 1200 μm, greater than or equal to 100 μm and less than or equal to 1000 μm, greater than or equal to 100 μm and less than or equal to 800 μm, greater than or equal to 100 μm and less than or equal to 500 μm, greater than or equal to 100 μm and less than or equal to 300 μm, greater than or equal to 300 μm and less than or equal to 2000 μm, greater than or equal to 300 μm and less than or equal to 1500 μm, greater than or equal to 300 μm and less than or equal to 1200 μm, greater than or equal to 300 μm and less than or equal to 1000 μm, greater than or equal to 300 μm and less than or equal to 800 μm, greater than or equal to 300 μm and less than or equal to 500 μm, greater than or equal to 500 μm and less than or equal to 2000 μm, greater than or equal to 500 μm and less than or equal to 1500 μm, greater than or equal to 500 μm and less than or equal to 1200 μm, greater than or equal to 500 μm and less than or equal to 1000 μm, greater than or equal to 500 μm and less than or equal to 800 μm, greater than or equal to 800 μm and less than or equal to 2000 μm, greater than or equal to 800 μm and less than or equal to 1500 μm, greater than or equal to 800 μm and less than or equal to 1200 μm, greater than or equal to 800 μm and less than or equal to 1000 μm, greater than or equal to 1000 μm and less than or equal to 2000 μm, greater than or equal to 1000 μm and less than or equal to 1500 μm, greater than or equal to 1000 μm and less than or equal to 1200 μm, greater than or equal to 1200 μm and less than or equal to 2000 μm, greater than or equal to 1200 μm and less than or equal to 1500 μm, or greater than or equal to 1500 μm and less than or equal to 2000 μm.

In the embodiments disclosed herein, the grating period (∧) is the total width (d) and separation (g) of one repeating unit of the in-coupler 110, as discussed further below. The grating period (∧) may be greater than or equal to 150 nm and less than or equal to 3000 nm, such as greater than or equal to 150 nm and less than or equal to 2500 nm, greater than or equal to 150 nm and less than or equal to 2000 nm, greater than or equal to 150 nm and less than or equal to 1500 nm, greater than or equal to 150 nm and less than or equal to 1000 nm, greater than or equal to 150 nm and less than or equal to 800 nm, greater than or equal to 150 nm and less than or equal to 500 nm, greater than or equal to 150 nm and less than or equal to 300 nm, greater than or equal to 300 nm and less than or equal to 3000 nm, greater than or equal to 300 nm and less than or equal to 2500 nm, greater than or equal to 300 nm and less than or equal to 2000 nm, greater than or equal to 300 nm and less than or equal to 1500 nm, greater than or equal to 300 nm and less than or equal to 1000 nm, greater than or equal to 300 nm and less than or equal to 800 nm, greater than or equal to 300 nm and less than or equal to 500 nm, greater than or equal to 500 nm and less than or equal to 3000 nm, greater than or equal to 500 nm and less than or equal to 2500 nm, greater than or equal to 500 nm and less than or equal to 2000 nm, greater than or equal to 500 nm and less than or equal to 1500 nm, greater than or equal to 500 nm and less than or equal to 1000 nm, greater than or equal to 500 nm and less than or equal to 800 nm, greater than or equal to 800 nm and less than or equal to 3000 nm, greater than or equal to 800 nm and less than or equal to 2500 nm, greater than or equal to 800 nm and less than or equal to 2000 nm, greater than or equal to 800 nm and less than or equal to 1500 nm, greater than or equal to 800 nm and less than or equal to 1000 nm, greater than or equal to 1000 nm and less than or equal to 3000 nm, greater than or equal to 1000 nm and less than or equal to 2500 nm, greater than or equal to 1000 nm and less than or equal to 2000 nm, greater than or equal to 1000 nm and less than or equal to 1500 nm, greater than or equal to 1500 nm and less than or equal to 3000 nm, greater than or equal to 1500 nm and less than or equal to 2500 nm, greater than or equal to 1500 nm and less than or equal to 2000 nm, greater than or equal to 2000 nm and less than or equal to 3000 nm, greater than or equal to 2000 nm and less than or equal to 2500 nm, or greater than or equal to 2500 nm and less than or equal to 3000 nm.

In the embodiments disclosed herein, the width (w) of the in-coupler 110 is measured along an axis that is perpendicular to the thickness (t) of the light guide 120. The width (w) may be greater than or equal to 50 μm and less than or equal to 5000 μm, such as greater than or equal to 50 μm and less than or equal to 4000 μm, greater than or equal to 50 μm and less than or equal to 3000 μm, greater than or equal to 50 μm and less than or equal to 2000 μm, greater than or equal to 50 μm and less than or equal to 1000 μm, greater than or equal to 50 μm and less than or equal to 800 μm, greater than or equal to 50 μm and less than or equal to 500 μm, greater than or equal to 50 μm and less than or equal to 300 μm, greater than or equal to 50 μm and less than or equal to 100 μm, greater than or equal to 100 μm and less than or equal to 5000 μm, greater than or equal to 100 μm and less than or equal to 4000 μm, greater than or equal to 100 μm and less than or equal to 3000 μm, greater than or equal to 100 μm and less than or equal to 2000 μm, greater than or equal to 100 μm and less than or equal to 1000 μm, greater than or equal to 100 μm and less than or equal to 800 m, greater than or equal to 100 μm and less than or equal to 500 μm, greater than or equal to 100 μm and less than or equal to 300 μm, greater than or equal to 300 μm and less than or equal to 5000 μm, greater than or equal to 300 μm and less than or equal to 4000 μm, greater than or equal to 300 μm and less than or equal to 3000 μm, greater than or equal to 300 μm and less than or equal to 2000 μm, greater than or equal to 300 μm and less than or equal to 1000 μm, greater than or equal to 300 μm and less than or equal to 800 μm, greater than or equal to 300 μm and less than or equal to 500 μm, greater than or equal to 500 μm and less than or equal to 5000 μm, greater than or equal to 500 μm and less than or equal to 4000 μm, greater than or equal to 500 μm and less than or equal to 3000 μm, greater than or equal to 500 μm and less than or equal to 2000 μm, greater than or equal to 500 μm and less than or equal to 1000 μm, greater than or equal to 500 μm and less than or equal to 800 μm, greater than or equal to 800 μm and less than or equal to 5000 μm, greater than or equal to 800 μm and less than or equal to 4000 μm, greater than or equal to 800 μm and less than or equal to 3000 μm, greater than or equal to 800 μm and less than or equal to 2000 μm, greater than or equal to 800 μm and less than or equal to 1000 μm, greater than or equal to 1000 μm and less than or equal to 5000 μm, greater than or equal to 1000 μm and less than or equal to 4000 μm, greater than or equal to 1000 μm and less than or equal to 3000 μm, greater than or equal to 1000 μm and less than or equal to 2000 μm, greater than or equal to 2000 μm and less than or equal to 5000 μm, greater than or equal to 2000 μm and less than or equal to 4000 μm, greater than or equal to 2000 μm and less than or equal to 3000 μm, greater than or equal to 3000 μm and less than or equal to 5000 μm, greater than or equal to 3000 μm and less than or equal to 4000 μm, or greater than or equal to 4000 μm and less than or equal to 5000 μm.

In embodiments, the duty cycle of the in-coupler 110 may be greater than or equal to 10% and less than or equal to 50%, such as greater than or equal to 10% and less than or equal to 45%, greater than or equal to 10% and less than or equal to 40%, greater than or equal to 10% and less than or equal to 30%, greater than or equal to 10% and less than or equal to 20%, greater than or equal to 20% and less than or equal to 50%, greater than or equal to 20% and less than or equal to 45%, greater than or equal to 20% and less than or equal to 40%, greater than or equal to 20% and less than or equal to 30%, greater than or equal to 30% and less than or equal to 50%, greater than or equal to 30% and less than or equal to 45%, greater than or equal to 30% and less than or equal to 40%, greater than or equal to 40% and less than or equal to 50%, greater than or equal to 40% and less than or equal to 45%, or greater than or equal to 45% and less than or equal to 50%.

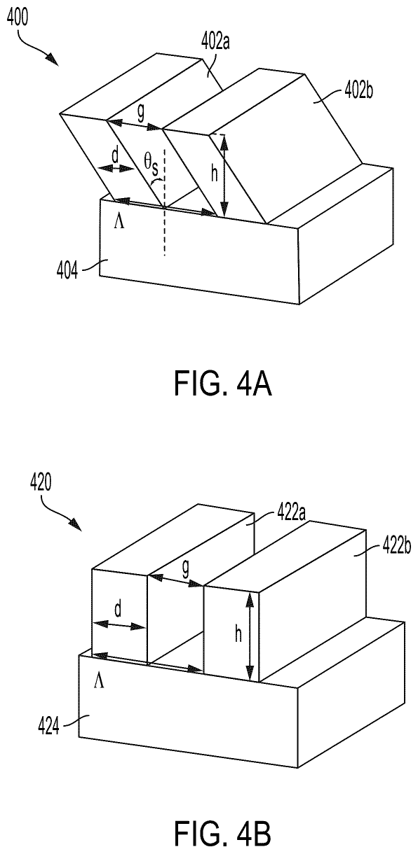

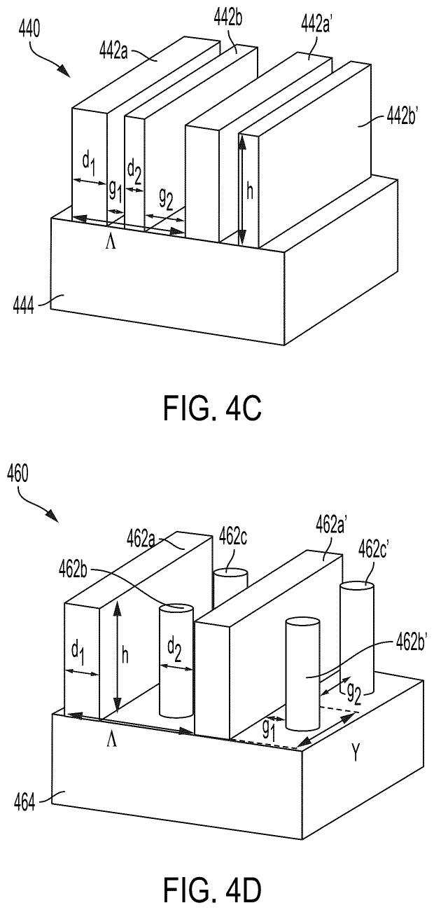

In embodiments, and as shown in FIGS. 4A to 4D and described in further detail herein, the in-coupler 110 may comprise a plurality of grating structures 112 disposed therein.

In embodiments, the grating structures 112 may have single shape profiles as schematically depicted in FIGS. 4A and 4B. For example, FIG. 4A schematically depicts an example slanted grating structure 400 comprised of or consisting of tilted rectangular structures (e.g. 402a and 402b) disposed on a light guide 404. Each tilted rectangular structure has a width (d), a height (h), and a slant angle(es) disclosed and described herein. Between adjacent rectangular structures 402a and 402b, there is a separation (g), measured as the minimum distance between the adjacent rectangular structures, disclosed and described herein. The width (d) and the separation (g) of the rectangular structures 402a and 402b together define the grating period (∧) of in-coupler 110 of the example slanted grating structure 400. As used herein, the slant angle (θₛ) is measured relative to the normal of the interface between the light guide 404 and the grating structure 400. As another example, FIG. 4B depicts an embodiment of a grating structure 420 in which rectangular structures (e.g. 422a and 422b) are disposed on a light guide 424 with a slant angle (θₛ) of 0°. The grating structure 420 is termed a rectangular ridge relief grating or single rectangular ridge relief grating.

In embodiments, the grating structures 112 may have a plurality of structures within one grating period and a plurality of shape profiles (rather than just rectangular) such as schematically depicted in FIGS. 4C and 4D. For example, FIG. 4C schematically depicts an example grating structure 440 of a double rectangular ridge relief grating comprised of or consisting of two rectangular structures (e.g. 442a and 442b or 442a′ and 442b′) per grating period. More specifically, rectangular structures 442a and 442b may comprise a first unit cell of a grating period and rectangular structures 442a′ and 442b′ may comprise a second unit cell of a grating period. The term “unit cell”, as understood by one skilled in the art, refers to the smallest repeating building block representing the arrangement of one or more grating structures within an in-coupler. The two rectangular structures 442a and 442b of the first unit cell disposed on a light guide 444 may have different widths (e.g. d₁ for 442a and d₂ for 442b), and the two rectangular structures 442a′ and 442b′ of the second unit cell disposed on light guide 444 may have different widths. In embodiments, rectangular structures 442a and 442a′ have the same widths and rectangular structures 442b and 442b′ have the same widths. Furthermore, the rectangular structures 442a, 442b, 442a′, and 442b′ may have the same height (h) or varying heights. A separation (g₁) is measured as the minimum distance between the two rectangular structures 442a and 442b in the same unit cell. Therefore, separation (g₁) may also be the minimum distance the two rectangular structures 442a′ and 442b′. And a separation (g₂) is measured as the minimum distance between one rectangular structure (e.g. 442b) in a first unit cell of a grating period and an adjacent rectangular structure (e.g., 442a′) of a second unit cell of an adjacent grating period as disclosed and described herein. The widths (d₁ and d₂) and the separations (g₁ and g₂) together define the grating period (∧) of the grating structure 440 such that, in the embodiment of FIG. 4C, the grating period (∧) is the sum of widths (d₁ and d₂) and of the separations (g₁ and g₂). The rectangular structures 442a, 442b, 442a′, 442b′ depicted in FIG. 4C may each be deposited with a slant angle (θₛ) greater than 0° as disclosed and described herein.

The grating structures disclosed herein are not limited to rectangular structures, and it is contemplated that other shape profiles such as cylindrical structures or even freeform structures may be included, alone or in any combinations, to maximize the relative in-coupling efficiency. As another example, FIG. 4D schematically depicts an example grating structure 460 with a block-and-pillar relief grating comprised of or consisting of a one-dimensional array of blocks or rectangular structures (e.g. 462a and 462a′) and a two-dimensional array of pillars or cylindrical structures (e.g. 462b, 462b′, 462c, and 462c′) disposed on a light guide 464. Each column of the cylindrical structures (e.g. 462b and 462c) is disposed between two rectangular structures (e.g. 462a and 462a′). Each rectangular structure has a width (d₁) and a height (h) as disclosed and described herein. Each cylindrical structure has a diameter (d₂) and a height (h) as disclosed and described herein. Between a rectangular structure and an adjacent cylindrical structure (e.g. 462a′ and 462b′), there is a separation (g₁), measured as the minimum distance between the adjacent rectangular and cylindrical structures, disclosed and described herein. Between two adjacent cylindrical structures in the same unit cell (e.g. 462b′ and 462c′), there is a separation (g₂), measured as the minimum distance between the adjacent cylindrical structures in the same unit cell, disclosed and described herein. In the exemplary grating structure 460 of FIG. 4D, the width (d₁) of the rectangular structure, the diameter (d₂) of the cylindrical structure, and the separation (g₁) between the rectangular structure and the adjacent cylindrical structure together define the grating period (∧) along the width of the grating structure 460. Furthermore, the diameter (d₂) of the cylindrical structure and the separation (g₂) between two cylindrical structures define a length (Y) of the unit cell, the length (Y) being transverse to the grating period (∧).

Furthermore, in some embodiments, the shape profile of each grating structure 112 may include a binary surface height distribution as opposed to continuous height variations. For example, the two rectangular structures (e.g. 442a and 442b) in a grating period of the exemplary grating structure 440 schematically depicted in FIG. 4C may have different surface heights as disclosed and described herein. As another example, the one-dimensional array of rectangular structures (e.g. 462a and 462a′) and the two-dimensional array of cylindrical structures (e.g. 462b, 462b′, 462c, and 462c′) of the exemplary grating structure 460 schematically depicted in FIG. 4D may have different surface heights as disclosed and described herein.

In embodiments, the height (h) of an in-coupling grating structure 112 (e.g., grating structures 400-460) may be greater than or equal to 150 nm and less than or equal to 750 nm, such as greater than or equal to 250 nm and less than or equal to 750 nm, greater than or equal to 350 nm and less than or equal to 750 nm, greater than or equal to 450 nm and less than or equal to 750 nm, greater than or equal to 550 nm and less than or equal to 750 nm, greater than or equal to 650 nm and less than or equal to 750 nm, greater than or equal to 150 nm and less than or equal to 650 nm, greater than or equal to 250 nm and less than or equal to 650 nm, greater than or equal to 350 nm and less than or equal to 650 nm, greater than or equal to 450 nm and less than or equal to 650 nm, greater than or equal to 550 nm and less than or equal to 650 nm, greater than or equal to 150 nm and less than or equal to 550 nm, greater than or equal to 250 nm and less than or equal to 550 nm, greater than or equal to 350 nm and less than or equal to 550 nm, greater than or equal to 450 nm and less than or equal to 550 nm, greater than or equal to 150 nm and less than or equal to 450 nm, greater than or equal to 250 nm and less than or equal to 450 nm, greater than or equal to 350 nm and less than or equal to 450 nm, greater than or equal to 150 nm and less than or equal to 350 nm, greater than or equal to 250 and less than or equal to 350 nm, or even greater than or equal to 150 nm and less than or equal to 250 nm, or any and all sub-ranges formed from any of these endpoints.

In embodiments, the width (d) (e.g., d₁, d₂) of an in-coupling grating structure 112 (wherein the width is equivalent to the diameter in embodiments in which the structure comprises cylindrical structures) may be greater than or equal to 30 nm and less than or equal to 250 nm, such as greater than or equal to 30 nm and less than or equal to 220 nm, greater than or equal to 30 nm and less than or equal to 190 nm, greater than or equal to 30 nm and less than or equal to 160 nm, greater than or equal to 30 nm and less than or equal to 130 nm, greater than or equal to 30 nm and less than or equal to 100 nm, greater than or equal to 30 nm and less than or equal to 70 nm, greater than or equal to 70 nm and less than or equal to 250 nm, greater than or equal to 70 nm and less than or equal to 220 nm, greater than or equal to 70 nm and less than or equal to 190 nm, greater than or equal to 70 nm and less than or equal to 160 nm, greater than or equal to 70 nm and less than or equal to 130 nm, greater than or equal to 70 nm and less than or equal to 100 nm, greater than or equal to 100 nm and less than or equal to 250 nm, greater than or equal to 100 nm and less than or equal to 220 nm, greater than or equal to 100 nm and less than or equal to 190 nm, greater than or equal to 100 nm and less than or equal to 160 nm, greater than or equal to 100 nm and less than or equal to 130 nm, greater than or equal to 130 nm and less than or equal to 250 nm, greater than or equal to 130 nm and less than or equal to 220 nm, greater than or equal to 130 nm and less than or equal to 190 nm, greater than or equal to 130 nm and less than or equal to 160 nm, greater than or equal to 160 nm and less than or equal to 250 nm, greater than or equal to 160 nm and less than or equal to 220 nm, greater than or equal to 160 nm and less than or equal to 190 nm, greater than or equal to 190 nm and less than or equal to 250 nm, greater than or equal to 190 nm and less than or equal to 220 nm, or even greater than or equal to 220 nm and less than or equal to 250 nm, or any and all sub-ranges formed from any of these endpoints.

In embodiments, the slant angle(es) of an in-coupling grating structure 112 may be greater than or equal to 0° and less than or equal to 50°, such as greater than or equal to 0° and less than or equal to 40°, greater than or equal to 0° and less than or equal to 30°, greater than or equal to 0° and less than or equal to 20°, greater than or equal to 0° and less than or equal to 10°, greater than or equal to 10° and less than or equal to 50°, greater than or equal to 10° and less than or equal to 40°, greater than or equal to 10° and less than or equal to 30°, greater than or equal to 10° and less than or equal to 20°, greater than or equal to 20° and less than or equal to 50°, greater than or equal to 20° and less than or equal to 40°, greater than or equal to 20° and less than or equal to 30°, greater than or equal to 30° and less than or equal to 50°, greater than or equal to 30° and less than or equal to 40°, or even greater than or equal to 40° and less than or equal to 50°, or any and all sub-ranges formed from any of these endpoints.

In embodiments, the separation (g) (e.g., g₁ and g₂) of two adjacent in-coupling grating structures 112 may be greater than or equal to 20 nm and less than or equal to 150 nm, such as greater than or equal to 20 nm and less than or equal to 120 nm, greater than or equal to 20 nm and less than or equal to 100 nm, greater than or equal to 20 nm and less than or equal to 80 nm, greater than or equal to 20 nm and less than or equal to 60 nm, greater than or equal to 20 nm and less than or equal to 40 nm, greater than or equal to 40 nm and less than or equal to 150 nm, greater than or equal to 40 nm and less than or equal to 120 nm, greater than or equal to 40 nm and less than or equal to 100 nm, greater than or equal to 40 nm and less than or equal to 80 nm, greater than or equal to 40 nm and less than or equal to 60 nm, greater than or equal to 60 nm and less than or equal to 150 nm, greater than or equal to 60 nm and less than or equal to 120 nm, greater than or equal to 60 nm and less than or equal to 100 nm, greater than or equal to 60 nm and less than or equal to 80 nm, greater than or equal to 80 nm and less than or equal to 150 nm, greater than or equal to 80 nm and less than or equal to 120 nm, greater than or equal to 80 nm and less than or equal to 100 nm, greater than or equal to 100 nm and less than or equal to 150 nm, greater than or equal to 100 nm and less than or equal to 120 nm, or even greater than or equal to 120 nm and less than or equal to 150 nm, or any and all sub-ranges formed from any of these endpoints.

In embodiments, the length (Y) of the unit cell of in-coupling grating structures 112 may be greater than or equal to 120 nm and less than or equal to 250 nm, such as greater than or equal to 120 nm and less than or equal to 220 nm, greater than or equal to 120 nm and less than or equal to 200 nm, greater than or equal to 120 nm and less than or equal to 180 nm, greater than or equal to 120 nm and less than or equal to 160 nm, greater than or equal to 120 nm and less than or equal to 140 nm, greater than or equal to 140 nm and less than or equal to 250 nm, greater than or equal to 140 nm and less than or equal to 220 nm, greater than or equal to 140 nm and less than or equal to 200 nm, greater than or equal to 140 nm and less than or equal to 180 nm, greater than or equal to 140 nm and less than or equal to 160 nm, greater than or equal to 160 nm and less than or equal to 250 nm, greater than or equal to 160 nm and less than or equal to 220 nm, greater than or equal to 160 nm and less than or equal to 200 nm, greater than or equal to 160 nm and less than or equal to 180 nm, greater than or equal to 180 nm and less than or equal to 250 nm, greater than or equal to 180 nm and less than or equal to 220 nm, greater than or equal to 180 nm and less than or equal to 200 nm, greater than or equal to 200 nm and less than or equal to 250 nm, greater than or equal to 200 nm and less than or equal to 220 nm, or greater than or equal to 220 nm and less than or equal to 250 nm.

In embodiments, the refractive index (n_{grating}) of the in-coupling grating structure 112 may be greater than or equal to 1.8 as measured in a visible wavelength range from 350 nm to 800 nm, such as greater than or equal to 1.8 and less than or equal to 2.7, such as greater than or equal to 1.8 and less than or equal to 2.7, greater than or equal to 1.8 and less than or equal to 2.5, or greater than or equal to 1.8 and less than or equal to 2.2, as measured in a visible wavelength range from 350 nm to 800 nm.

In embodiments, the in-coupler 110 (in particular, the in-coupling grating structure 112) may comprise a dielectric material, a plasmonic material, or combinations thereof. In some embodiments, the in-coupler 110 may comprise a dielectric material comprising SiN, TiO₂, SiO₂, or combinations thereof. In other embodiments, the in-coupler 110 may comprise a plasmonic material comprising metallic materials, such as Au, Ag, Pt, Cu, Pd, Al, Mg, or combinations thereof. In further embodiments, the in-coupler 110 may comprise a combination of the dielectric material and the plasmonic material described herein.

In embodiments, the thickness-to-width ratio (t/w) of an optical combiner 100 comprising an in-coupler 110 and a light guide 120 described herein may be greater than or equal to 5×10⁻⁵ and less than or equal to 5×10⁻¹, such as greater than or equal to 5×10⁻⁵ and less than or equal to 2.5×10⁻¹, greater than or equal to 5×10⁻⁵ and less than or equal to 1×10⁻¹, greater than or equal to 5×10⁻⁵ and less than or equal to 5×10⁻², greater than or equal to 5×10⁻⁵ and less than or equal to 1×10⁻², greater than or equal to 5×10⁻⁵ and less than or equal to 5×10⁻³, greater than or equal to 5×10⁻⁵ and less than or equal to 1×10⁻³, greater than or equal to 5×10⁻⁵ and less than or equal to 5×10⁻⁴, greater than or equal to 5×10⁻⁵ and less than or equal to 1×10⁻⁴, greater than or equal to 1×10⁻⁴ and less than or equal to 5×10⁻¹, greater than or equal to 1×10⁻⁴ and less than or equal to 2.5×10⁻¹, greater than or equal to 1×10⁻⁴ and less than or equal to 1×10⁻¹, greater than or equal to 1×10⁻⁴ and less than or equal to 5×10⁻², greater than or equal to 1×10⁻⁴ and less than or equal to 1×10⁻², greater than or equal to 1×10⁻⁴ and less than or equal to 5×10⁻³, greater than or equal to 1×10⁴ and less than or equal to 1×10⁻³, greater than or equal to 1×10⁻⁴ and less than or equal to 5×10⁻⁴, greater than or equal to 5×10⁻⁴ and less than or equal to 5×10⁻¹, greater than or equal to 5×10⁻⁴ and less than or equal to 2.5×10⁻¹, greater than or equal to 5×10⁻⁴ and less than or equal to 1×10⁻¹, greater than or equal to 5×10⁻⁴ and less than or equal to 5×10⁻², greater than or equal to 5×10⁻⁴ and less than or equal to 1×10⁻², greater than or equal to 5×10⁻⁴ and less than or equal to 5×10⁻³, greater than or equal to 5×10⁻⁴ and less than or equal to 1×10⁻³, greater than or equal to 1×10⁻³ and less than or equal to 5×10⁻¹, greater than or equal to 1×10⁻³ and less than or equal to 2.5×10⁻¹, greater than or equal to 1×10⁻³ and less than or equal to 1×10⁻¹, greater than or equal to 1×10⁻³ and less than or equal to 5×10⁻², greater than or equal to 1×10⁻³ and less than or equal to 1×10⁻², greater than or equal to 1×10⁻³ and less than or equal to 5×10⁻³, greater than or equal to 5×10⁻³ and less than or equal to 5×10⁻¹, greater than or equal to 5×10⁻³ and less than or equal to 2.5×10⁻¹, greater than or equal to 5×10⁻³ and less than or equal to 1×10⁻¹, greater than or equal to 5×10⁻³ and less than or equal to 5×10⁻², greater than or equal to 5×10⁻³ and less than or equal to 1×10⁻², greater than or equal to 1×10⁻² and less than or equal to 5×10⁻¹, greater than or equal to 1×10⁻² and less than or equal to 2.5×10⁻¹, greater than or equal to 1×10⁻² and less than or equal to 1×10⁻¹, greater than or equal to 1×10⁻² and less than or equal to 5×10⁻², greater than or equal to 5×10⁻² and less than or equal to 5×10⁻¹, greater than or equal to 5×10⁻² and less than or equal to 2.5×10⁻¹, greater than or equal to 5×10⁻² and less than or equal to 1×10⁻¹, greater than or equal to 1×10⁻¹ and less than or equal to 5×10⁻¹, greater than or equal to 1×10⁻¹ and less than or equal to 2.5×10⁻¹, or even greater than or equal to 2.5×10⁻¹ and less than or equal to 5×10⁻¹, or any and all sub-ranges formed from any of these endpoints

In embodiments, the field of view of the optical combiner 100 may be greater than or equal to −60° and less than or equal to +60°, such as greater than or equal to −55° and less than or equal to +55°, greater than or equal to −50° and less than or equal to +50°, greater than or equal to −45° and less than or equal to +45°, greater than or equal to −40° and less than or equal to +40°, greater than or equal to −35° and less than or equal to +35°, greater than or equal to −30° and less than or equal to +30°, greater than or equal to −20° and less than or equal to +20°, or greater than or equal to −10° and less than or equal to +10°, measured relative to the normal of an incident surface of the optical combiner 100.

Referring back to FIG. 3 and as shown in FIG. 2, the method 300 continues at block 340 with calculating a total in-coupling efficiency (ηₜₒₜₐₗ) of the optical combiner 100 as a function of an angle of incidence (θᵢₙ) of an incident light comprising a wavelength (λ) within the field of view of the optical combiner 100.

The total in-coupling efficiency (ηₜₒₜₐₗ) of the optical combiner 100 is calculated according to Eq. (1) defined hereinabove. Referring to Eq. (1) defined hereinabove, f in Eq. (1) represents a fractional area of the in-coupler 110 where the incident light interacts once with the in-coupler 110 and does not experience any loss due to secondary interactions. The fraction f is calculated according to Eq. (2) defined hereinabove as a function of θᵣ, which is a reflected angle of the incident light from a back surface of the light guide defined by Eq. (3) defined hereinabove.

The remainder of the grating area may be divided into N sections, where

$$N = ⌊ \frac{1}{f} ⌋ .$$

N denotes the number of the secondary interactions that the (N+1)^{th} fractional area of the in-coupler, where the incident light interacts N times with the in-coupler. That is, in the first one of the N sections (i.e., f₂), the incident light suffers only one secondary interaction, in the second of the N sections (i.e., f₃), the incident light suffers two secondary interactions, and so on. In the last remaining section (i.e., f_{N+1}), the incident light suffers N secondary interactions. The last fraction, f_{N+1}, is given by: f_{N+1}=1−Nf.

In embodiments, the angle of incidence (fin) of the incident light may be greater than or equal to −60° and less than or equal to 60°, or greater than or equal to −55° and less than or equal to 55°, or greater than or equal to −50° and less than or equal to 50°, or greater than or equal to −45° and less than or equal to 45°, or greater than or equal to −40° and greater than or equal to 40°, or greater than or equal to 35° and less than or equal to 35°, or greater than or equal to −30° and less than or equal to 30°, or greater than or equal to −25° and less than or equal to +25°, or any range or combination of ranges encompassing these endpoints, measured relative to the normal of an incident surface of the optical combiner 100.

The first-order deflection efficiency η_{1T}(θᵢₙ) and the zeroth-order reflection efficiency η_{0R}(θᵣ) may depend on the wavelength and polarization state of the incident light. In embodiments, the incident light may have a wavelength greater than or equal to 350 nm and less than or equal to 800 nm. In embodiments, the incident light may have a TE/TM polarization extinction ratio of greater than or equal to 20 dB, such as greater than or equal to 30 dB, greater than or equal to 40 dB, greater than or equal to 20 dB and less than or equal to 40 dB, greater than or equal to 20 dB and less than or equal to 30 dB, or greater than or equal to 30 dB and less than or equal to 40 dB.

In embodiments disclosed herein, the in-coupling efficiency of the optical combiner 100 is such that the following condition of Eq. (6) is satisfied:

$$\frac{{η}_{1 T}}{1 - {η}_{0 R}} \geq x \qquad Eq . ( 6 )$$

wherein η_{1T} is the first-order deflection efficiency of the optical combiner and η_{0R} is the zeroth-order reflection efficiency of the optical combiner, as discussed above. The x in Eq. (6) is about 0.2 or greater, or about 0.3 or greater, or about 0.4 or greater, or about 0.5 or greater, or about 0.6 or greater, or about 0.7 or greater, or about 0.8 or greater, or about 0.9 or greater, or about 0.95 or greater. Additionally or alternatively, x is about 1.0 or less, or about 0.95 or less, or about 0.9 or less, or about 0.8 or less, or about 0.7 or less, or about 0.6 or less, or about 0.5 or less, or about 0.4 or less, or about 0.3 or less. In some embodiments, x is in a range from about 0.2 to about 1.0, or about 0.3 to about 0.95, or about 0.4 to about 0.9, or about 0.5 to about 0.8, or about 0.6 to about 0.7, or any range or combination of ranges encompassing these endpoints.

Eq. (6a) shows one exemplary embodiment of Eq. (6) when x is 0.2 or greater:

$$\frac{{η}_{1 T}}{1 - {η}_{0 R}} \geq 0.2 . \qquad Eq . ( 6 a )$$

And Eq. (6b) shows another exemplary embodiment of Eq. (6) when x is less than or equal to 1.0 and greater than or equal to 0.2:

$$1. \geq \frac{{η}_{1 T}}{1 - {η}_{0 R}} \geq 0.2 . \qquad Eq . ( 6 b )$$

In Eq. (6), η_{1T} is the first-order deflection efficiency of the optical combiner and is less than or equal to about 0.80, or less than or equal to about 0.75, or less than or equal to about 0.70, or less than or equal to about 0.65, or less than or equal to about 0.60, or less than or equal to about 0.55, or less than or equal to about 0.50, or any range or combination of ranges encompassing these endpoints. In Eq. (6), η_{0R} is the zeroth-order reflection efficiency of the optical combiner and is greater than or equal to about 0.20, or greater than or equal to about 0.25, or greater than or equal to about 0.30, or greater than or equal to about 0.35, or greater than or equal to about 0.40, or greater than or equal to about 0.45, or greater than or equal to about 0.50, or greater than or equal to about 0.55, or greater than or equal to about 0.60, or greater than or equal to about 0.65, or greater than or equal to about 0.70, or greater than or equal to about 0.75, or greater than or equal to about 0.80, or greater than or equal to about 0.85, or greater than or equal to about 0.90, or greater than or equal to about 0.95. Additionally or alternatively, nor is about 1.00 or less, or about 0.95 or less, or about 0.90 or less, or about 0.85 or less, or about 0.80 or less, or about 0.75 or less, or about 0.70 or less, or about 0.65 or less, or about 0.60 or less, or about 0.55 or less, or about 0.50 or less, or about 0.45 or less, or about 0.40 or less, or about 0.35 or less, or about 0.30 or less, or about 0.25 or less, or about 0.20 or less. In embodiments, nor is in a range from about 0.20 to about 1.00, or about 0.25 to about 0.95, or about 0.30 to about 0.90, or about 0.35 to about 0.85, or about 0.40 to about 0.80, or about 0.45 to about 0.75, or about 0.50 to about 0.70, or about 0.55 to about 0.65, or about 0.60 to about 0.65, or any range or combination of ranges encompassing these endpoints.

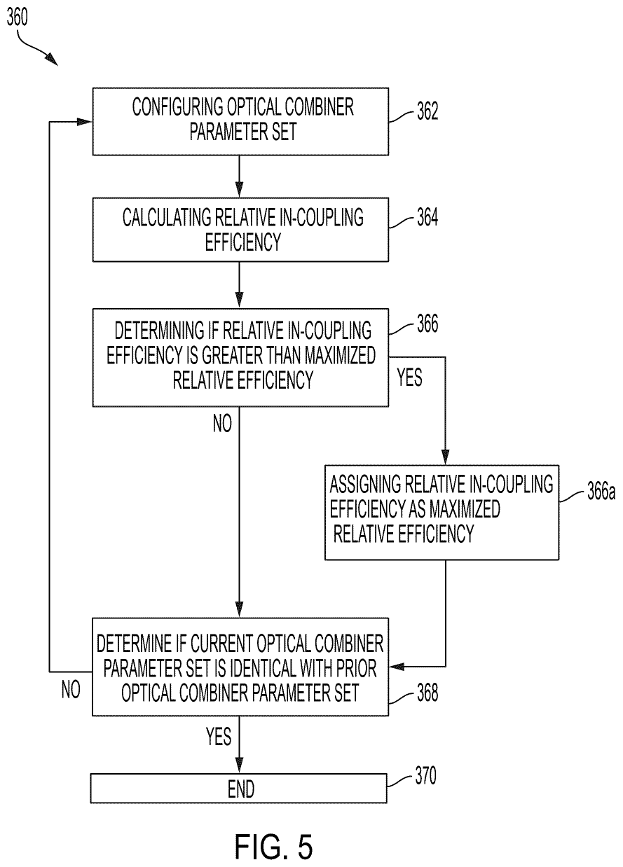

Referring back to FIG. 3, the method 300 continues at method 360 with configuring the optical combiner parameter set to maximize a relative in-coupling efficiency of the optical combiner 100. Referring now to FIG. 5, the method 360 of FIG. 3 may further include steps for configuring the optical combiner parameter set to maximize a relative in-coupling efficiency of the optical combiner 100.

For example, the steps may repeat or form an iterative process as schematically illustrated in FIG. 5. The steps of method 360 begin at block 362 with configuring the optical combiner parameter set and continue at block 364 with calculating the relative in-coupling efficiency associated with the optical combiner parameter set. Configuring the optical combiner parameter set comprises altering one or more variables or parameters within the optical combiner parameter set, for example, and without limitation, the width or the height of the grating structures. The relative in-coupling efficiency is defined as a minimum field efficiency (MFE=min[ηₜₒₜₐₗ]) of the combiner parameter over angles of incidence within the field of view normalized by a theoretical efficiency maximum (ηₘₐₓ) of the combiner parameter. The theoretical efficiency maximum is determined by the optical combiner 100 system geometry (e.g. the t/w ratio) and reflected angles (θᵣ), given by ηₘₐₓ=η_{1T} if f≥1 or ηₘₐₓ=f if f<1.

The steps of method 360 continue at block 366 with determining if the relative in-coupling efficiency is greater than a maximized relative efficiency associated with earlier optical combiner parameter sets. If the relative in-coupling efficiency is greater than the maximized relative efficiency associated with earlier optical combiner parameter sets, continue at block 366a and assign the currently maximized relative efficiency to the relative in-coupling efficiency; otherwise, assign the currently maximized relative efficiency to the maximized relative efficiency associated with earlier optical combiner parameter sets.

Upon assigning the currently maximized relative efficiency, the steps of method 360 continue at block 368 with determining if the current optical combiner parameter set is identical with the last earlier optical combiner parameter set. If the parameter sets are identical, the steps end at block 370; if not, the method may restart at block 362. Through these steps, an optical combiner parameter set resulting in maximized relative in-coupling efficiency is configured, and the maximized relative in-coupling efficiency is determined.

In embodiments, the maximized relative in-coupling efficiency may be greater than or equal to 0.5 and less than or equal to 1.0, such as greater than or equal to 0.8 and less than or equal to 1.0, greater than or equal to 0.9 and less than or equal to 1.0, greater than or equal to 0.95 and less than or equal to 1.0, greater than or equal to 0.5 and less than or equal to 0.95, greater than or equal to 0.8 and less than or equal to 0.95, greater than or equal to 0.9 and less than or equal to 0.95, greater than or equal to 0.5 and less than or equal to 0.9, greater than or equal to 0.8 and less than or equal to 0.9, or even greater than or equal to 0.5 and less than or equal to 0.8, or any and all sub-ranges formed from any of these endpoints.

Unexpectedly, as the light guide 120 thickness decreases and/or the thickness-to-width ratio of the optical combiner 100 decreases, the optical combiner parameter set resulting in maximized relative in-coupling efficiency does not necessarily exhibit the highest possible first-order deflection efficiency. Namely, methods disclosed and described herein obtain maximized relative in-coupling efficiency so long as the sum of the first-order deflection efficiency (η_{1T}) and zeroth-order reflection efficiency (η_{0R}) of the optical combiner 100 is maximized. In embodiments, the maximized relative in-coupling efficiency may be greater than or equal to 0.5 and less than or equal to 1.0 and the maximized relative first-order deflection efficiency may be greater than or equal to 0.2 and less than or equal to 0.6, such as greater than or equal to 0.2 and less than or equal to 0.5, greater than or equal to 0.2 and less than or equal to 0.4, greater than or equal to 0.2 and less than or equal to 0.3, greater than or equal to 0.3 and less than or equal to 0.6, greater than or equal to 0.3 and less than or equal to 0.5, greater than or equal to 0.3 and less than or equal to 0.4, greater than or equal to 0.4 and less than or equal to 0.6, greater than or equal to 0.4 and less than or equal to 0.5, or even greater than or equal to 0.5 and less than or equal to 0.6, or any and all sub-ranges formed from any of these endpoints.

That is, in embodiments, a ratio of the maximized relative in-coupling efficiency to the maximized relative first-order deflection efficiency may be greater than or equal to 1.3 and less than or equal to 2.2, such as greater than or equal to 1.4 and less than or equal to 1.9, greater than or equal to 1.4 and less than or equal to 1.8, greater than or equal to 1.4 and less than or equal to 1.7, greater than or equal to 1.4 and less than or equal to 1.6, greater than or equal to 1.4 and less than or equal to 1.5, greater than or equal to 1.5 and less than or equal to 1.9, greater than or equal to 1.5 and less than or equal to 1.8, greater than or equal to 1.5 and less than or equal to 1.7, greater than or equal to 1.5 and less than or equal to 1.6, greater than or equal to 1.6 and less than or equal to 1.9, greater than or equal to 1.6 and less than or equal to 1.8, greater than or equal to 1.6 and less than or equal to 1.7, greater than or equal to 1.7 and less than or equal to 1.9, greater than or equal to 1.7 and less than or equal to 1.8, or even greater than or equal to 1.8 and less than or equal to 1.9, or any and all sub-ranges formed from any of these endpoints.

For example, the thickness-to-width ratio of the optical combiner 100 may be greater than or equal to 1×10⁻⁴ and less than or equal to 0.1, the maximized relative in-coupling efficiency may be greater than or equal to 0.87 and less than or equal to 0.96, and the maximized relative first-order deflection efficiency may greater than or equal to 0.54 and less than or equal to 0.59. In other examples, the thickness-to-width ratio of the optical combiner 100 may be greater than or equal to 1×10⁻⁴ and less than or equal to 0.1, the maximized relative in-coupling efficiency may be greater than or equal to 0.5 and less than or equal to 0.67, and the maximized relative first-order deflection efficiency may be greater than or equal to 0.31 and less than or equal to 0.36. In another example, the thickness-to-width ratio of the optical combiner 100 may be greater than or equal to 1×10⁻⁴ and less than or equal to 0.05, the maximized relative in-coupling efficiency may be greater than or equal to 0.73 and less than or equal to 0.8, and the maximized relative first-order deflection efficiency may be greater than or equal to 0.46 and less than or equal to 0.48. In further examples, the thickness-to-width ratio of the optical combiner 100 may be greater than or equal to 1×10⁻⁴ and less than or equal to 0.01, the maximized relative in-coupling efficiency may be greater than or equal to 0.71 and less than or equal to 0.7, and the maximized relative first-order deflection efficiency may be greater than or equal to 0.49 and less than or equal to 0.5.

### Shape Modification

Reference will now be made in detail to another method of forming thin optical combiners 100 having improved in-coupling efficiency by modifying shape profiles of grating structures 112 disposed in in-couplers 110 of the thin optical combiners 100.

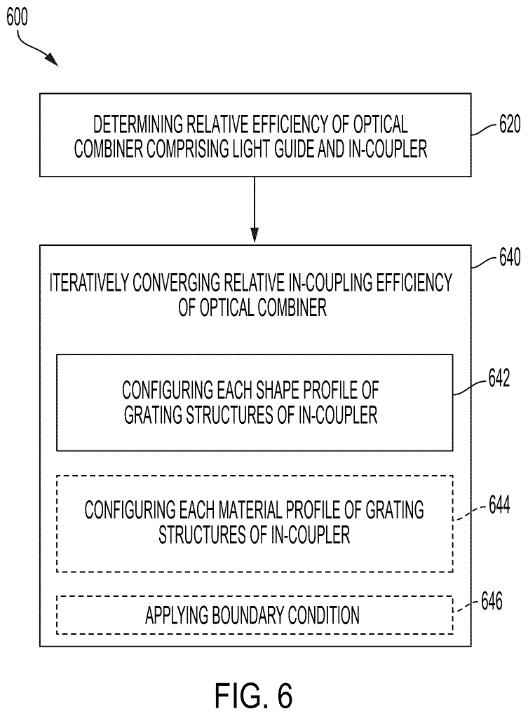

Referring to FIG. 6 and as shown in FIGS. 4A to 4D, the method 600 of forming an optical combiner 100 comprising a light guide 120 and an in-coupler 110 begins at block 620 with determining a relative efficiency of the optical combiner 100. In embodiments, the relative efficiency of an optical combiner 100 may be determined according to Eq. (1) to Eq. (3) disclosed and described herein.

Referring still to FIG. 6, the method 600 continues at block 640 with iteratively converging the relative in-coupling efficiency by conducting sub-step 642 with configuring each shape profile of grating structures 112 of the in-coupler 110. The in-coupler 110 may comprise a plurality of grating structures 112 disposed therein. Each grating structure 112 of the plurality of grating structures 112 has a shape profile described and disclosed herein.

According to embodiments, the iteratively converging of the relative efficiency of the optical combiner 100 may be achieved by configuring of the shape profile of each grating structure 112 of the plurality of grating structures 112. The configuring of the shape profile of each grating structure 112 of the plurality of grating structures 112 may be performed by executing an inverse design algorithm. As used herein, the term “inverse design algorithm” refers to an algorithm that searches for different shape profiles to achieve a desired functionality. For example, the desired functionality of an optical combiner 100 may include a maximized in-coupling relative efficiency or an in-coupling relative efficiency that is within 40%, 20%, or 10% of the theoretical efficiency maximum (ηₘₐₓ) of the optical combiner 100.

In some embodiments, the iteratively converging of the relative efficiency of the optical combiner 100 may be achieved by configuring the shape profile of each grating structure 112 of the plurality of grating structures 112 to maximize the relative in-coupling efficiency of the optical combiner 100.

In some embodiments, the iteratively converging of the relative efficiency of the optical combiner 100 may be achieved by configuring the shape profile of each grating structure 112 of the plurality of grating structures 112 to adjust the relative in-coupling efficiency of the optical combiner 100 such that the relative in-coupling efficiency of the optical combiner 100 is within 40%, 20%, or 10% of the theoretical efficiency maximum (ηₘₐₓ) of the optical combiner 100.

In other embodiments, the iteratively converging of the relative efficiency of the optical combiner 100 may be achieved by configuring the shape profile of each grating structure 112 of the plurality of grating structures 112 to adjust the relative in-coupling efficiency of the optical combiner 100 such that the relative in-coupling efficiency of the optical combiner 100 is within 40%, 20%, or 10% of the theoretical efficiency maximum (ηₘₐₓ) of the optical combiner 100 and to maximize the relative in-coupling efficiency of the optical combiner 100.

Each grating structure 112 of the plurality of grating structures 112 comprises a material profile. Referring back to FIG. 6, the method 600 may therefore continue at block 640 with iteratively converging the relative in-coupling efficiency by optionally conducting sub-step 644 with configuring each material profile of grating structures 112 of the in-coupler 110.

According to embodiments, the iteratively converging of the relative efficiency of the optical combiner 100 may be achieved by optionally configuring the material profile of each grating structure 112 of the plurality of grating structures 112. For example, the configuring of the material profile of each grating structure 112 of the plurality of grating structures 112 may be incorporated into the configuring of the shape profile of each grating structure 112 of the plurality of grating structures 112 performed by executing an inverse design algorithm described hereinabove.

In some embodiments, the iteratively converging of the relative efficiency of the optical combiner 100 may be achieved by configuring the material profile of each grating structure 112 of the plurality of grating structures 112 to maximize the relative in-coupling efficiency of the optical combiner 100.

In some embodiments, the iteratively converging of the relative efficiency of the optical combiner 100 may be achieved by configuring the material profile of each grating structure 112 of the plurality of grating structures 112 to adjust the relative in-coupling efficiency of the optical combiner 100 such that the relative in-coupling efficiency of the optical combiner 100 is within 40%, 20%, or 10% of the theoretical efficiency maximum (ηₘₐₓ) of the optical combiner 100.

In other embodiments, the iteratively converging of the relative efficiency of the optical combiner 100 may be achieved by configuring the material profile of each grating structure 112 of the plurality of grating structures 112 to adjust the relative in-coupling efficiency of the optical combiner 100 such that the relative in-coupling efficiency of the optical combiner 100 is within 40%, 20%, or 10% of the theoretical efficiency maximum (ηₘₐₓ) of the optical combiner 100 and to maximize the relative in-coupling efficiency of the optical combiner 100.

In embodiments, the material profile may include a material of the grating structure 112 and a permittivity or refractive index (n_{grating}) associated with the material described and disclosed herein. For example, the material profile may comprise dielectric materials, plasmonic materials, or combinations thereof.

Referring back to FIG. 6, the method 600 continues at block 640 with iteratively converging the relative in-coupling efficiency by optionally conducting sub-step 646 with applying a boundary condition.

According to embodiments, a boundary condition may be applied to control formation of a boundary in the in-coupler 110, such as ensuring no new boundaries are formed to avoid the appearance of new structures (e.g., particles or holes) in the in-coupler 110 to be maximized or ensuring no existing grating structures are removed. It should be understood that various shape maximization algorithms and boundary conditions within the knowledge of a person of ordinary skill in the art may be applied, alone, in any combinations, or in any sequence. In specific examples, iteratively converging the relative efficiency of the optical combiner 100 may include calculating a gradient in the relative efficiency of the optical combiner 100 with respect to the configured shape profile for each iteration and determine whether the gradient for current iteration is greater than the gradient of early iterations. The gradient may be calculated as a function of the angle of incidence (θᵢₙ) at an interface between the in-coupler 110 and the light guide 120. In more specific examples, the gradient may be calculated under a boundary condition u_{⊥} according to Eq. (4) defined hereinabove, in which u_{⊥} is the magnitude of displacement in a boundary of the shape profile at each iteration.

Reference will now be made in detail to methods of coupling an incident light into optical combiners 100 disclosed and described herein.

According to embodiments, the method of coupling an incident light into an optical combiner 100 comprising an in-coupler 110 and a light guide 120 includes diffracting the incident light comprising a wavelength (λ) with the in-coupler 110 into the light guide 120 at an angle of incidence (θᵢₙ) of the incident light relative to the normal of an incident surface of the optical combiner 100 within a field of view of the optical combiner 100.

In embodiments, the in-coupler 110 comprises a grating period (∧) and a width (w) disclosed and described herein. In some embodiments, the in-coupler 110 may have a duty cycle disclosed and described herein. The in-coupler 110 may further comprise a purity of grating structures 112 having a height (h), a width (d), a slant angle (θₛ), a refractive index (n_{grating}), or a length (Y) of a unit cell as disclosed and described herein. The grating structures 112 may comprise a material disclosed and described herein.

In embodiments, the light guide 120 may comprise a refractive index (n_{substrate}) and a thickness (t) disclosed herein. The light guide 120 may comprise a material disclosed and described herein.

In embodiments, the optical combiner 100 may have a relative in-coupling efficiency greater than or equal to 0.5 and less than or equal to 1.0, where the relative in-coupling efficiency of the optical combiner 100 is defined as a minimum field efficiency (MFE=min[ηₜₒₜₐₗ]) normalized by a theoretical efficiency maximum (ηₘₐₓ) of the optical combiner 100. The relative in-coupling efficiency, the minimum field efficiency, and theoretical efficiency maximum of the optical combiner 100 are calculated according to Eq. (1), Eq. (2), and Eq. (3) defined hereinabove, given by ηₘₐₓ=η_{1T} if f≥1 or ηₘₐₓ=f if f<1.

### EXAMPLES

The following Examples are offered by way of illustration and are presented in a manner such that one skilled in the art should recognize are not meant to be limiting to the present disclosure as a whole or to the appended claims.

The following examples illustrate the methods of forming an optical combiner described and disclosed hereinabove. Specifically, examples 1 to 4 illustrate the parametric maximization process and Example 5 illustrates the shape modification process according to embodiments disclosed and described herein.

### Example Parametric Maximization Process

In an example parametric maximization process, the first-order deflection efficiency η_{1T}(θᵢₙ) and the zeroth-order reflection efficiency η_{0R}(θᵣ) were calculated according to Eq. (1), Eq. (2), and Eq. (3) defined hereinabove using commercial software (Lumerical Finite-Difference Time-Domain (FTDT) or COMSOL Finite Element Analysis (FEA)). The first-order deflection efficiency η_{1T}(θᵢₙ) and the zeroth-order reflection efficiency η_{0R}(θᵣ) were calculated as a function of an angle of incidence (θᵢₙ) greater than or equal to −25° and less than or equal to +25° within a field of view greater than or equal to −50° and less than or equal to +50°. The field of view was determined based on a grating period of 386 nm and a light guide made of glass with a refractive index (n_{substrate}) of 1.9. For purposes of the parametric maximization, the thickness-to-width ratio (t/w) of the optical combiner was varied from 0.2 to 1×10⁻⁴. The thickness-to-width ratio (t/w) was selected to ensure there is at least one secondary interaction within the field-of-view. Additionally, the material of the grating structures was selected to be SiN with a refractive index (n_{grating}) of about 2.0.

### Example 1—Slanted Relief Gratings

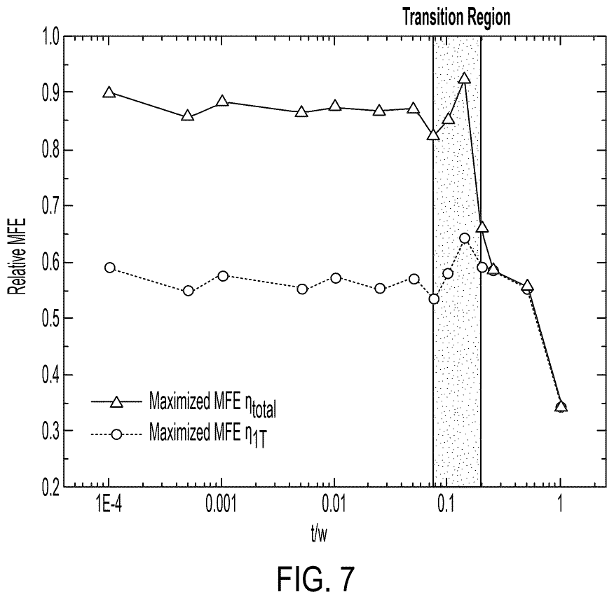

Referring now to Table 1 and FIG. 7, the maximized relative in-coupling efficiencies of example optical combiners having slanted gratings as the in-coupler calculated according to the example parametric maximization process described hereinabove are shown.

TABLE 1

| | | Duty | | Relative | | Relative | |
|---|---|---|---|---|---|---|---|
| | Height | Cycle | Slant Angle | MFE | MFE | MFE | MFE |
| t/w | (nm) | (%) | (Degrees) | ηₜₒₜₐₗ | ηₜₒₜₐₗ | η_{1T} | η_{1T} |
| 0.25 | 700 | 60 | 45 | 0.58 | 0.19 | 0.58 | 0.19 |
| 0.1 | 650 | 30 | 45 | 0.87 | 0.11 | 0.58 | 0.073 |
| 0.075 | 500 | 30 | 45 | 0.87 | 0.097 | 0.54 | 0.060 |
| 0.050 | 400 | 30 | 45 | 0.87 | 0.057 | 0.57 | 0.037 |
| 0.025 | 450 | 20 | 45 | 0.88 | 0.030 | 0.55 | 0.019 |
| 0.01 | 350 | 30 | 10 | 0.93 | 0.012 | 0.57 | 7.4 × 10⁻³ |
| 0.005 | 350 | 30 | 10 | 0.89 | 6.1 × 10⁻³ | 0.55 | 3.8 × 10⁻³ |
| 0.001 | 350 | 30 | 10 | 0.93 | 1.2 × 10⁻³ | 0.58 | 7.5 × 10⁻⁴ |
| 5 × 10⁻⁴ | 400 | 20 | 20 | 0.88 | 6.2 × 10⁻⁴ | 0.55 | 3.9 × 10⁻⁴ |
| 1 × 10⁻⁴ | 350 | 30 | 10 | 0.96 | 1.2 × 10⁻⁴ | 0.59 | 7.3 × 10⁻⁵ |

In Table 1, the minimum values of the total in-coupling efficiency and the first-order deflection efficiency with the field of view of each example optical combiner are reported as MFE ηₜₒₜₐₗ and MFE η_{1T}, respectively. The minimum values of the total in-coupling efficiency and the first-order deflection efficiency are divided by the theoretical efficiency maximum of each example optical combiner and reported as relative MFE ηₜₒₜₐₗ and relative MFE η_{1T}, respectively. In FIG. 7, a plot is provided showing the relative minimum field efficiency (y-axis), including relative MFE nₜₒₜₐₗ and relative MFE η_{1T}, maximized as a function of the thickness-to-width ratios (t/w) (x-axis).

Both Table 1 and FIG. 7 show that the relative MFE ηₜₒₜₐₗ values of example optical combiners remained constantly above 0.87 within a range of thickness-to-width ratios (t/w) from 0.05 to 1×10⁻⁴. Both Table 1 and FIG. 7 also show a transition region from a thickness-to-width ratio (t/w) of 0.078 to a thickness-to-width ratio (t/w) of 0.2. In the transition region, the relative MFE ηₜₒₜₐₗ values decreased to below 0.6. On the other hand, the relative MFE η_{1T} values remained constantly below 0.6 for a thickness-to-width ratio (t/w) of 1×10⁻⁴ to a thickness-to-width ratio (t/w) of 0.2. The changes in the relative MFE ηₜₒₜₐₗ values and the relative MFE η_{1T} values as a function of thickness-to-width ratio (t/w) indicate that the transition region defines the transition from thin optical combiners to thick optical combiners as well as the onset of secondary interactions and their impact on the design of thin optical combiners.

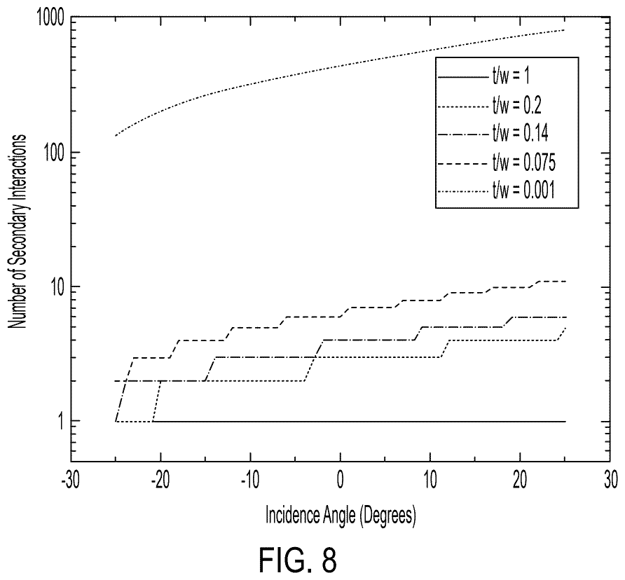

Referring to FIG. 8, a plot is provided showing the number of secondary interactions (y-axis) that occurred in the example optical combiners with different thickness-to-width ratios (t/w), as specified in the legend, as a function of the incidence angles (x-axis). FIG. 8 shows that a relatively low number secondary interactions occurred at positive angles of incidence in a thick optical combiner having a thickness-to-width ratio (t/w) of 0.2, with a maximum of three secondary interactions occurring at θᵢₙ=+25°. On the other hand, FIG. 8 shows the number of secondary interactions rapidly increased in thin optical combiners having thickness-to-width ratios (t/w) less than or equal to 0.14, with two or more interactions allowed at every angle of incidence.

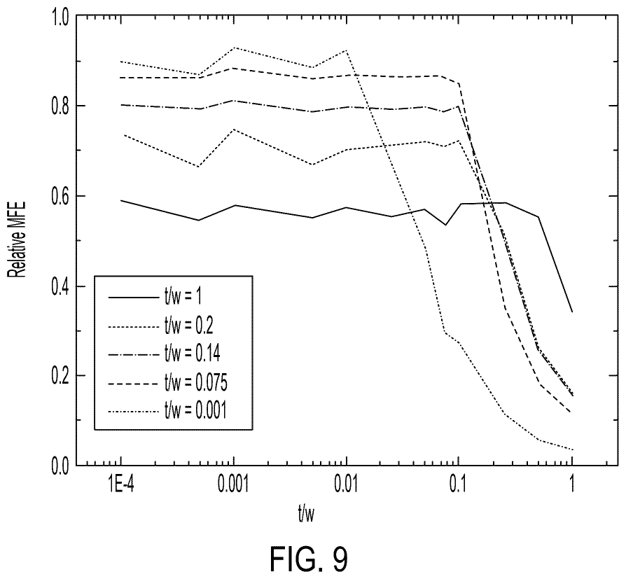

Referring to FIG. 9, a plot is provided showing the relative MFE ηₜₒₜₐₗ values (y-axis) achieved across a wide range of thickness-to-width ratios (x-axis) by an example optical combiner designed for a specific thickness-to-width ratio, as specified in the legend. FIG. 9 shows that a grating design maximized for a thin optical combiner having a particular thickness-to-width ratio was generally applicable to thin optical combiners across a wide range of thickness-to-width ratios (t/w) from 1×10⁻⁴ to 1×10⁻¹, with the relative MFE ηₜₒₜₐₗ values maintained greater than or equal to 0.8.For example, the relative MFE ηₜₒₜₐₗ values of thin optical combiners having thickness-to-width ratios (t/w) from 1×10⁻⁴ to 1×10⁻¹ remained constantly greater than 0.85 with a grating particularly designed and maximized for a thin optical combiner having a thickness-to-width ratio of 0.075. On the other hand, while not wishing to be bound by theory, a grating design maximized for a thick optical combiner did not exhibit high relative MFE ηₜₒₜₐₗ values when applied to thin optical combiners because, for a thick optical combiner, the total in-coupling efficiency may be primarily attributed to the first deflection efficiency mir and its MFE ηₜₒₜₐₗ value is given by the MFE η_{1T} value.

Accordingly, FIG. 8 and FIG. 9 again show including secondary interactions and the zeroth-order reflection efficiency into the grating design considerations lead to greatly maximized in-coupling efficiency and expanded solution space for industrial application. The impact of including secondary interactions and the zeroth-order reflection efficiency into the grating design considerations is further illustrated and supported by subsequent Examples.

### Example 2—Single Ridge Relief Gratings

Referring now to Table 2, the maximized relative in-coupling efficiencies of example optical combiners having single ridge relief gratings as the in-coupler calculated according to the example parametric maximization process described hereinabove are shown.

TABLE 2

| | | | Rel- | | Rel- | |
|---|---|---|---|---|---|---|
| | | Rectangular | ative | | ative | |
| | Height | Ridge Width | MFE | MFE | MFE | MFE |
| t/w | (nm) | (nm) | ηₜₒₜₐₗ | ηₜₒₜₐₗ | η_{1T} | η_{1T} |
| 0.25 | 150 | 210 | 0.32 | 0.10 | 0.27 | 0.085 |
| 0.1 | 150 | 180 | 0.58 | 0.074 | 0.35 | 0.044 |
| 0.075 | 150 | 180 | 0.50 | 0.055 | 0.31 | 0.035 |
| 0.050 | 150 | 180 | 0.50 | 0.032 | 0.35 | 0.023 |
| 0.025 | 150 | 150 | 0.58 | 0.020 | 0.34 | 0.012 |
| 0.01 | 300 | 90 | 0.63 | 8.1 × 10⁻³ | 0.35 | 4.5 × 10⁻³ |
| 0.005 | 150 | 120 | 0.60 | 4.2 × 10⁻³ | 0.33 | 2.3 × 10⁻³ |
| 0.001 | 150 | 120 | 0.64 | 8.3 × 10⁻⁴ | 0.35 | 4.5 × 10⁻⁴ |
| 5 × 10⁻⁴ | 150 | 120 | 0.59 | 4.2 × 10⁻⁴ | 0.33 | 2.3 × 10⁻⁴ |
| 1 × 10⁻⁴ | 200 | 60 | 0.67 | 8.3 × 10⁻⁵ | 0.36 | 4.4 × 10⁻⁵ |

As shown in Table 2, the relative MFE ηₜₒₜₐₗ values of the example optical combiners having single ridge relief gratings rapidly increased from 0.32 to 0.58 when the thickness-to-width ratio (t/w) was reduced from 0.25 to 0.1. The relative MFE ηₜₒₜₐₗ values remained around or above 0.6 for thin optical combiners with the thickness-to-width ratios (t/w) of from 0.01 to 1×10⁻⁴. On the other hand, the relative MFE η_{1T} values remained around or below 0.36 for thick and thin optical combiners. The result again indicates that the transition from thick to thin optical combiners having single ridge relief gratings occurred between thickness-to-width ratios (t/w) of 0.25 and 0.1 and that secondary interactions are significant to the design of thin optical combiners—i.e., the relative MFE ηₜₒₜₐₗ values were nearly 2-fold of the relative MFE η_{1T} values.

### Example 3—Double Ridge Relief Gratings

Referring now to Table 3, the maximized relative in-coupling efficiencies of example optical combiners having double ridge relief gratings as the in-coupler calculated according to the example parametric maximization process described hereinabove are shown.

TABLE 3

| | | Ridge 1 | Ridge 2 | Ridge | Relative | | Relative | |
|---|---|---|---|---|---|---|---|---|
| | Height | Width | Width | Separation | MFE | MFE | MFE | MFE |
| t/w | (nm) | (nm) | (nm) | (nm) | ηₜₒₜₐₗ | ηₜₒₜₐₗ | η_{1T} | η_{1T} |
| 0.25 | 150 | 60 | 120 | 30 | 0.27 | 0.085 | 0.27 | 0.085 |
| 0.1 | 300 | 60 | 150 | 50 | 0.51 | 0.064 | 0.46 | 0.058 |
| 0.075 | 300 | 60 | 180 | 50 | 0.51 | 0.057 | 0.46 | 0.051 |
| 0.050 | 400 | 90 | 30 | 150 | 0.73 | 0.048 | 0.47 | 0.031 |
| 0.025 | 350 | 30 | 180 | 110 | 0.73 | 0.025 | 0.46 | 0.016 |
| 0.01 | 350 | 30 | 150 | 110 | 0.76 | 0.01 | 0.47 | 6.1 × 10⁻³ |
| 0.005 | 350 | 30 | 120 | 110 | 0.72 | 5.0 × 10⁻³ | 0.46 | 3.2 × 10⁻³ |
| 0.001 | 350 | 30 | 120 | 110 | 0.76 | 1.0 × 10⁻³ | 0.48 | 6.2 × 10⁻⁴ |
| 5 × 10⁻⁴ | 350 | 30 | 180 | 110 | 0.72 | 5.1 × 10⁻⁴ | 0.47 | 3.3 × 10⁻⁴ |
| 1 × 10⁻⁴ | 350 | 30 | 150 | 110 | 0.80 | 9.8 × 10⁻⁵ | 0.47 | 5.8 × 10⁻⁵ |

As shown in Table 3, the relative MFE ηₜₒₜₐₗ values of the example optical combiners having double ridge relief gratings increased from 0.27 to 0.73 when the thickness-to-width ratio (t/w) was reduced from 0.25 to 0.05. The relative MFE ηₜₒₜₐₗ values remained around or above 0.7 for thin optical combiners with the thickness-to-width ratios (t/w) of from 0.05 to 1×10⁻⁴. On the other hand, the relative MFE η_{1T} values remained around or below 0.48 for thick and thin optical combiners. The result indicates that the transition from thick to thin optical combiners having double ridge relief gratings occurred between thickness-to-width ratios (t/w) of 0.25 and 0.05. For the thin optical combiners, the relative MFE ηₜₒₜₐₗ values were around or greater than 1.5 times of the relative MFE η_{1T} values.

### Example 4—Block-and-Pillar Relief Gratings

Referring now to Table 4, the maximized relative in-coupling efficiencies of example optical combiners having block-and-pillar relief gratings as the in-coupler calculated according to the example parametric maximization process described hereinabove are shown.

TABLE 4

| | | Pillar | Block | Block-Pillar | Unit | Relative | | Relative | |
|---|---|---|---|---|---|---|---|---|---|
| | Height | Diameter | Width | Separation | Cell Y | MFE | MFE | MFE | MFE |
| t/w | (nm) | (nm) | (nm) | (nm) | (nm) | ηₜₒₜₐₗ | ηₜₒₜₐₗ | η_{1T} | η_{1T} |
| 0.25 | 150 | 70 | 170 | 70 | 150 | 0.52 | 0.17 | 0.47 | 0.15 |
| 0.1 | 150 | 110 | 130 | 90 | 150 | 0.61 | 0.078 | 0.49 | 0.062 |
| 0.075 | 150 | 110 | 130 | 90 | 150 | 0.61 | 0.068 | 0.48 | 0.054 |
| 0.050 | 400 | 110 | 110 | 90 | 150 | 0.64 | 0.042 | 0.49 | 0.032 |
| 0.025 | 350 | 110 | 110 | 90 | 150 | 0.66 | 0.023 | 0.49 | 0.017 |
| 0.01 | 400 | 130 | 110 | 50 | 200 | 0.77 | 0.010 | 0.49 | 6.4 × 10⁻³ |
| 0.005 | 400 | 130 | 110 | 50 | 200 | 0.71 | 4.9 × 10⁻³ | 0.49 | 3.4 × 10⁻³ |
| 0.001 | 400 | 130 | 110 | 50 | 200 | 0.76 | 9.8 × 10⁻⁴ | 0.50 | 6.5 × 10⁻⁴ |
| 5 × 10⁻⁴ | 350 | 110 | 130 | 70 | 150 | 0.69 | 4.9 × 10⁻⁴ | 0.49 | 3.5 × 10⁻⁴ |
| 1 × 10⁻⁴ | 400 | 130 | 110 | 50 | 200 | 0.77 | 9.5 × 10⁻⁵ | 0.49 | 6 × 10⁻⁵ |

As shown in Table 4, the relative MFE ηₜₒₜₐₗ values of the example optical combiners having block-and-pillar relief gratings increased from 0.52 to 0.77 when the thickness-to-width ratio (t/w) was reduced from 0.25 to 0.01. The relative MFE ηₜₒₜₐₗ values remained around or above 0.7 for optical combiners with the thickness-to-width ratios (t/w) of from 0.01 to 1×10⁻⁴. On the other hand, the relative MFE η_{1T} values remained around or below 0.45 for all optical combiners. While the transition from thick to thin optical combiners having block-and-pillar relief gratings was not as rapid as optical combiners having other gratings as shown in Examples 1 to 3, the result again indicates that the impact of secondary interactions increases as the thickness-to-width ratio of an optical combiner decreases. As shown in Table 5, the relative MFE ηₜₒₜₐₗ values were around or greater than 1.4 times of the relative MFE η_{1T} values for optical combiners having thickness-to-width ratios (t/w) from 0.01 to 1×10⁻⁴.

### Example 5—Shape Modification for Ridge Relief Gratings

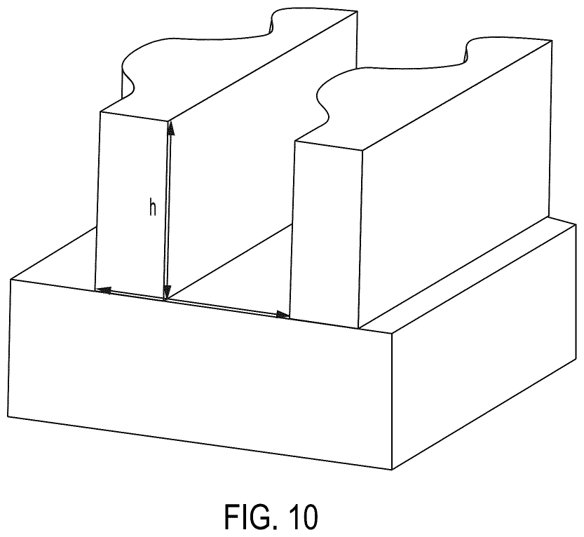

Shape profiles of rectangular structures of a single ridge relief grating disposed in optical combiners having thickness-to-width ratios (t/w) from 0.5 to 1×10⁻⁴ were modified in accordance with an embodiment method schematically illustrated in FIG. 6 and described herein. FIG. 10 schematically depicts the modified grating structures. Referring now to Table 5, the maximized relative in-coupling efficiencies of example optical combiners having single ridge relief gratings as the in-coupler after the shape modification as described herein are shown.

TABLE 5

| | | Minimum | | Relative |
|---|---|---|---|---|
| | Height | Separation | MFE | MFE |
| t/w | (nm) | (nm) | ηₜₒₜₐₗ | ηₜₒₜₐₗ |
| 0.5 | 162 | 213 | 9.79 | 0.159 |
| 0.25 | 153 | 147 | 9.18 | 0.289 |
| 0.1 | 159 | 120 | 6.43 | 0.508 |
| 0.075 | 145 | 179 | 4.48 | 0.402 |
| 0.050 | 132 | 86 | 3.74 | 0.573 |
| 0.025 | 224 | 13 | 1.79 | 0.519 |
| 0.01 | 177 | 89 | 1.05 | 0.805 |
| 0.005 | 337 | 132 | 0.55 | 0.798 |
| 0.001 | 325 | 135 | 0.11 | 0.856 |
| 5 × 10⁻⁴ | 312 | 135 | 0.05 | 0.778 |
| 1 × 10⁻⁴ | 327 | 124 | 0.0099 | 0.801 |

The resulting grating structures after shape modification may remain as rectangular ridges or have free-form, amorphous shapes as illustrated in FIG. 10. Nonetheless, comparing Table 5 and Table 2, the Relative MFE ηₜₒₜₐₗ values for thin optical combiners with thickness-to-width ratios (t/w) of from 0.01 to 1×10⁻⁴ improved from about 0.6 to about or above 0.8—i.e., greater than 30% of improvement—after the shape modification.

To conclude, embodiments and examples described herein have demonstrated efficiency maximization for thin optical combiners by including both the first-order deflection efficiency and the zeroth-order reflection efficiency into consideration and by modifying shape profiles of the grating structures. As demonstrated, examples disclosed have achieved a relative in-coupling efficiency within 40% of the theoretical efficiency maximum for thin optical combiners (t/w<0.2). Accordingly, methods disclosed and described herein provide expanded and effective solution space for designing thin light guide combiners for next-generation augmented reality systems with reduced system weight.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

What is claimed is:

1. An optical combiner comprising:
a light guide having a thickness t; and
an in-coupler disposed on the light guide and having a width w,
wherein a thickness-to-width ratio (t/w) of the optical combiner is greater than or equal to 5×10⁻⁵ and less than or equal to 5×10⁻¹, and
wherein an in-coupling efficiency of the optical combiner of an incident light on the in-coupler is such that the following condition is satisfied:
$$\frac{{η}_{1 T}}{1 - {η}_{0 R}} \geq 0.2 ,$$
wherein η_{1T} is a first-order deflection efficiency of the optical combiner, and η_{0R} is a zeroth-order reflection efficiency of the optical combiner and is greater than or equal to 0.20.

2. The optical combiner of claim 1, wherein an angle of incidence of the incident light is greater than or equal to −60° and less than or equal to +60°.

3. The optical combiner of claim 1, wherein the following condition is satisfied:
$$\frac{{η}_{1 T}}{1 - {η}_{0 R}} \geq 0.3 .$$

4. The optical combiner of claim 3, wherein the following condition is satisfied:
$$\frac{{η}_{1 T}}{1 - {η}_{0 R}} \geq 0.5 .$$

5. The optical combiner of claim 1, wherein the following condition is satisfied:
$$1. \geq \frac{{η}_{1 T}}{1 - {η}_{0 R}} \geq 0.2 .$$

6. The optical combiner of claim 1, wherein η_{1T} is less than or equal to 0.80.

7. The optical combiner of claim 6, wherein η_{1T} is less than or equal to 0.75.

8. The optical combiner of claim 7, wherein η_{1T} is less than or equal to 0.50.

9. The optical combiner of claim 1, wherein η_{0R} is 0.25 or greater.

10. The optical combiner of claim 1, wherein η_{0R} is 0.2 or greater and 1.0 or less.

11. The optical combiner of claim 1, wherein the light guide has a refractive index of 1.8 or greater in a wavelength range from 350 nm to 800 nm.

12. The optical combiner of claim 1, wherein the light guide comprises SiN, TiO₂, SiO₂, or combinations thereof.

13. The optical combiner of claim 1, wherein the thickness t of the light guide is greater than or equal to 10 μm and less than or equal to 2000 μm.

14. The optical combiner of claim 1, wherein the in-coupler comprises grating structures with a grating period (∧) that is greater than or equal to 150 nm and less than or equal to 3000 nm.

15. The optical combiner of claim 1, wherein the in-coupler comprises grating structures that each have a height (h) greater than or equal to 150 nm and less than or equal to 750 nm.

16. The optical combiner of claim 1, wherein the in-coupler comprises grating structures that each have a width (d) greater than or equal to 30 nm and less than or equal to 250 nm.

17. The optical combiner of claim 1, wherein the in-coupler comprises grating structures that each have a slant angle (θₛ) greater than or equal to 0° and less than or equal to 50°.

18. The optical combiner of claim 1, wherein the in-coupler comprises grating structures such that a separation (g) of two adjacent grating structures is greater than or equal to 20 nm and less than or equal to 150 nm.

19. The optical combiner of claim 1, wherein the thickness-to-width ratio (t/w) is greater than or equal to 5×10⁻⁵ and less than or equal to 2.5×10⁻¹.

20. The optical combiner of claim 1, wherein a field of view of the optical combiner is greater than or equal to −60° and less than or equal to +60°, relative to the normal of an incident surface of the optical combiner.

21. The optical combiner of claim 1, wherein a total in-coupling efficiency (ηₜₒₜₐₗ) of the optical combiner as a function of an angle of incidence (θᵢₙ) of the incident light, which comprises a wavelength (λ) within a field of view of the optical combiner, is greater than or equal to 0.5 and less than or equal to 1.0, the total in-coupling efficiency (ηₜₒₜₐₗ) of the optical combiner is calculated according to:
$${η}_{total} = f {η}_{1 T} ( \frac{1 - {η}_{0 R}^{N}}{1 - {η}_{0 R}} ) + {f}_{N + 1} {η}_{1 T} {η}_{0 R}^{N} ,$$
wherein:
f is a fractional area of the in-coupler where the incident light interacts once with the in-coupler as defined by:
$$f = \frac{2 t}{w} tan {θ}_{r} ,$$
wherein θᵣ is a reflected angle of the incident light from a back surface of the light guide as defined by:
$${n}_{substrate} sin {θ}_{r} = \frac{λ}{Λ} sin {θ}_{in} ,$$
N is the number of secondary interactions determined by
$$N = ⌊ \frac{1}{f} ⌋ ,$$
and
f_{N+1} is a remaining fractional area of the in-coupler where the incident light experiences N secondary interactions calculated according to f_{N+1}=1−Nf.
